(19) United States
(12) Patent Application Publication
(10) Pub. No.: US 2026/0267270 A1
(43) Pub. Date: Sep. 10, 2026

(54) IMAGE FORMING APPARATUS

(71) Applicant: CANON KABUSHIKI KAISHA, Tokyo (JP)

(72) Inventors: Shunsuke Matsushita, Kanagawa (JP); Toshihiko Takayama, Kanagawa (JP); Shuichi Tetsuno, Kanagawa (JP)

(21) Appl. No.: 19/556,221

(22) Filed: Mar. 4, 2026

(30) Foreign Application Priority Data
Mar. 10, 2025 (JP) 2025-037722

(51) Int. Cl. G03G 15/00; G03G 15/041; G03G 15/08; G03G 15/20

(52) U.S. Cl. CPC G03G 15/556; G03G 15/0415; G03G 15/0808; G03G 15/0856; G03G 15/0865; G03G 15/0889; G03G 15/2017; G03G 15/2064; G03G 15/50

(57) ABSTRACT

Disclosed is an image forming apparatus including an image bearing member, an accommodation portion configured to accommodate a developer, an attachment portion configured to allow a replenishment container to be attached and detached, a developer bearing member, and a controller configured to execute an image forming operation and a predetermined non-image-forming operation. The controller is configured to, in a case where a value related to a cumulative traveling distance of the developer bearing member in the predetermined non-image-forming operation from a time point when the replenishment operation is executed exceeds a predetermined threshold value, execute first processing to lower an execution frequency of the predetermined non-image-forming operation as compared with before the value related to the cumulative traveling distance exceeds the threshold value.

### BACKGROUND

### Field of the Technology

The present disclosure relates to an image forming apparatus that forms an image on a recording material.

### Description of the Related Art

Japanese Patent Laid-Open No. 2012-189712 discloses stopping a printing operation when detecting the toner remainder amount and elongating an execution time interval of the toner remainder amount detection in the case of determining that the toner remainder amount does not cause a process cartridge to expire.

Japanese Patent Laid-Open No. 2013-218123 discloses adjusting the start timing of the pressurization and temperature control of a fixing means, and the start timing of an image formation preliminary operation including raising the charging bias and the developing bias, on the basis of the toner remainder amount of the process cartridge and the lifetime of the developing roller.

### SUMMARY

According to the present disclosure, an image forming apparatus capable of suppressing deterioration of toner can be provided.

An aspect of the present disclosure provides an image forming apparatus including an image bearing member, an accommodation portion configured to accommodate a developer, an attachment portion configured to allow a replenishment container to be attached and detached, the attachment portion including a replenishment port communicating with the accommodation portion, a developer bearing member configured to rotate while bearing the developer in the accommodation portion and develop a developer image by supplying the developer to the image bearing member, and a controller configured to execute an image forming operation of forming an image on a recording material by using the image bearing member and the developer bearing member, and a predetermined non-image-forming operation of not forming the image on the recording material, the predetermined non-image-forming operation including an operation of rotating the developer bearing member, wherein the accommodation portion is configured to be replenished with the developer by a replenishment operation in which the developer is supplied to the accommodation portion from the replenishment container attached to the attachment portion through the replenishment port and then the replenishment container is detached from the attachment portion, and wherein the controller is configured to, in a case where a value related to a cumulative traveling distance of the developer bearing member in the predetermined non-image-forming operation from a time point when the replenishment operation is executed exceeds a predetermined threshold value, execute first processing to lower an execution frequency of the predetermined non-image-forming operation as compared with before the value related to the cumulative traveling distance exceeds the threshold value.

Another aspect of the present disclosure provides an image forming apparatus including an image bearing member, an accommodation portion configured to store a developer, an attachment portion configured to allow a replenishment container to be attached and detached, the attachment portion including a replenishment port communicating with the accommodation portion, a developer bearing member configured to rotate while bearing the developer in the accommodation portion and develop a developer image by supplying the developer to the image bearing member, and a controller configured to execute an image forming operation of forming an image on a recording material by using the image bearing member and the developer bearing member, and a predetermined non-image-forming operation of not forming the image on the recording material, the predetermined non-image-forming operation including an operation of rotating the developer bearing member, wherein the accommodation portion is configured to be replenished with the developer by a replenishment operation, in which the developer is supplied to the accommodation portion from the replenishment container attached to the attachment portion through the replenishment port and then the replenishment container is detached from the attachment portion, and wherein the controller is configured to, in a case where a value related to a cumulative traveling distance of the developer bearing member in the predetermined non-image-forming operation from a time point when the replenishment operation is executed exceeds a predetermined threshold value, shorten a time in which the developer bearing member is rotationally driven in the predetermined non-image-forming operation as compared with before the value related to the cumulative traveling distance exceeds the threshold value.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of an image forming apparatus according to Example 1.

FIG. 2A is a diagram illustrating a toner pack according to Example 1.

FIG. 2B is a diagram illustrating toner replenishment.

FIG. 3 is a diagram illustrating a light guiding member of a toner amount sensor according to Example 1.

FIG. 4 is a circuit diagram of a sensor portion of the toner amount sensor according to Example 1.

FIG. 5 is a block diagram illustrating a control system of the image forming apparatus according to Example 1.

FIG. 6 is a flowchart illustrating a control example of a pre-start operation according to Example 1.

FIGS. 7A to 7C are each a timing chart illustrating an execution example of a predetermined non-image-forming operation according to Example 1.

FIG. 8 is a flowchart illustrating a control example related to the switch from a normal mode to a suppression mode according to Example 1.

FIG. 9 is a flowchart illustrating a control example related to the switch from the suppression mode to the normal mode according to Example 1.

FIGS. 10A and 10B are diagrams respectively illustrating transition of an inter-replenishment specific traveling distance Rn and transition of an inter-replenishment traveling distance Ry with respect to a cumulative print count according to Example 1.

FIGS. 11A and 11B are diagrams respectively illustrating transition of an inter-replenishment specific traveling distance Rn and transition of an inter-replenishment traveling distance Ry with respect to a cumulative print count according to Comparative Example 1.

FIG. 12 is a flowchart illustrating a control example according to Example 2.

FIGS. 13A and 13B are diagrams respectively illustrating transition of an inter-replenishment specific traveling distance Rn and transition of an inter-replenishment traveling distance Ry with respect to a cumulative print count according to Example 2.

FIGS. 14A and 14B are diagrams respectively illustrating transition of an inter-replenishment specific traveling distance Rn and transition of an inter-replenishment traveling distance Ry with respect to a cumulative print count according to Comparative Example 2-1.

FIGS. 15A and 15B are diagrams respectively illustrating transition of an inter-replenishment specific traveling distance Rn and transition of an inter-replenishment traveling distance Ry with respect to a cumulative print count according to Comparative Example 2-2.

FIGS. 16A and 16B are diagrams respectively illustrating transition of an inter-replenishment specific traveling distance Rn and transition of an inter-replenishment traveling distance Ry with respect to a cumulative print count according to Example 3.

FIGS. 17A and 17B are diagrams respectively illustrating transition of an inter-replenishment specific traveling distance Rn and transition of an inter-replenishment traveling distance Ry with respect to a cumulative print count according to Comparative Example 3.

### DESCRIPTION OF THE EMBODIMENTS

Embodiments of the present disclosure will be described with reference to drawings.

### Example 1

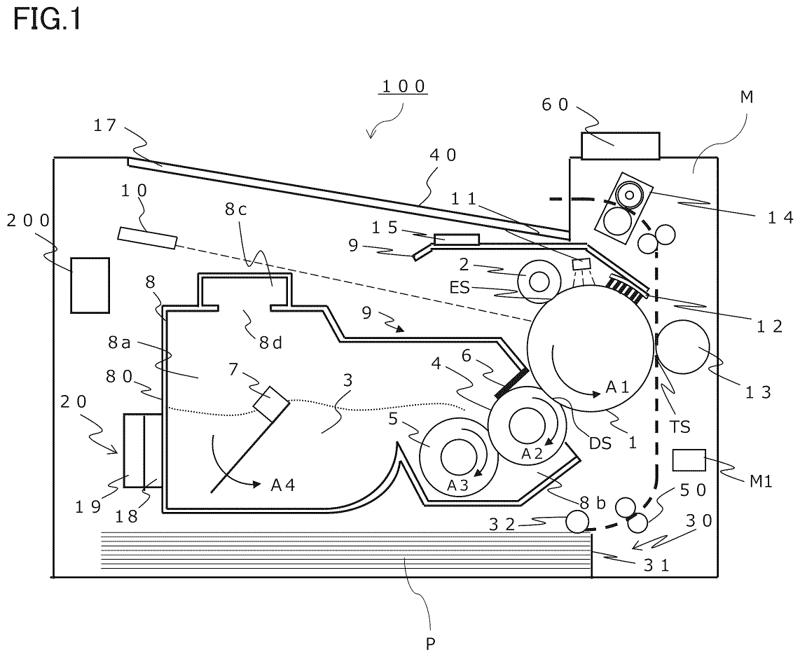

First, Example 1 serving as one embodiment will be described. FIG. 1 is a schematic section view of an image forming apparatus 100 according to Example 1. The image forming apparatus 100 is a monochromatic laser printer capable of forming a monochromatic black image on a recording material P by an electrophotographic process of a direct transfer system.

The image forming apparatus 100 includes an image forming apparatus main body (hereinafter referred to as an apparatus main body M), and a process unit 9. Here, the apparatus main body M is a part of the image forming apparatus 100 other than the process unit 9. The process unit 9 is an example of an image forming portion that forms a toner image (developer image) by an electrophotographic process by using toner 3 as a developer. The process unit 9 includes a photosensitive drum 1 serving as an image bearing member, and at least one process member that acts on the photosensitive drum 1 to execute steps of an electrophotographic process such as charging, exposure, development, transfer, and de-electrification.

To be noted, the image forming apparatus to which the technique of the present disclosure can be applied is not limited to an apparatus having the same basic configuration as the image forming apparatus 100 described in Example 1. For example, the image forming apparatus may be a color laser printer that includes a plurality of process units 9 and an intermediate transfer member such as an intermediate transfer belt as an image forming portion and that forms a color image on a recording material P by using toners of a plurality of colors.

The process unit 9 of the present example is a process cartridge that is configured to be replaceable by being attached to and detached from the apparatus main body M by the user. To be noted, the process unit 9 may be fixed to the apparatus main body M in a form not considering attachment and detachment by the user. That is, a configuration in which the process unit 9 can be regarded as part of the apparatus main body M may be employed.

The process unit 9 includes the photosensitive drum 1 serving as an image bearing member, a charging roller 2 serving as a charging unit, a developing device 8 serving as a developing unit, a de-electrification device 11 serving as a de-electrification unit, a brush member 12 serving as a paper dust collection member, and a memory 15. In addition, the process unit 9 includes a toner amount sensor 20 (toner remainder amount sensor) serving as a detection portion that detects a toner amount (toner remainder amount) in the developing device 8.

The photosensitive drum 1 is a photosensitive member (electrophotographic photosensitive member) having a rotatable drum shape (cylindrical shape). The charging roller 2 is a roller-shaped charging member disposed to abut the surface (outer peripheral surface) of the photosensitive drum 1 or have a predetermined gap from the surface of the photosensitive drum 1. The developing device 8 includes a developing roller 4 serving as a developer bearing member (developing member). The details of the developing device 8 will be described later. The memory 15 is a nonvolatile storage device. The charging roller 2, the brush member 12, and the developing roller 4 are arranged to abut the surface (outer peripheral surface) of the photosensitive drum 1.

The process unit 9 is configured to be easily attachable to and detachable from the apparatus main body M with an attachment guide and a positioning member provided in one or both of the apparatus main body M and the process unit 9.

In addition, the image forming apparatus 100 includes a transfer roller 13 serving as a transfer unit, an exposing device 10 serving as an exposing unit, and a fixing device 14 serving as a fixing unit. The transfer roller 13 is a roller-shaped transfer member disposed to abut the surface of the photosensitive drum 1. The fixing device 14 includes, for example, a fixing roller including a halogen lamp serving as a heating portion, and a pressurizing roller (pressurizing member) that is in pressure contact with the fixing roller (fixing member). A fixing nip is formed between the fixing roller and the pressurizing roller. The fixing device 14 may be an induction heating (IH) fixing device including a coil for induction heating as a heating portion, or a ceramic heater in which a pattern of a heat-generating resistor is printed on a ceramic substrate may be used as a heating portion. In addition, the fixing member may be, for example, a tubular film. The fixing member and the pressurizing member may be an endless member (fixing belt) stretched over a plurality of rollers.

Further, the image forming apparatus 100 includes a controller 200 that executes overall control of the image forming apparatus 100, and an operation panel 60 serving as an operation portion. The operation panel 60 includes a display portion for displaying information to an operator such as a user or a service worker in accordance with control by the controller 200, and an input portion for inputting information to the controller 200 in accordance with an operation by the operator. The display portion includes a liquid crystal panel. The input portion includes a touch panel structure of the liquid crystal panel and a physical key such as a print execution button.

### Image Forming Operation

Next, an image forming operation that the image forming apparatus 100 of Example 1 executes will be described. The image forming operation is a series of operation (printing operation) in which the image forming apparatus 100 feeds the recording material P, an image is formed on the recording material P by using the photosensitive drum 1, the developing roller 4, and the like, and the recording material P is discharged to the outside of the apparatus. In addition, a series of tasks in which images of a designated number are output onto recording materials P by repeatedly executing the image forming operation on the basis of an instruction from the user will be referred to as an image forming job (print job). In the description below, a simple expression of “job” mostly refers to an image forming job. FIG. 1 illustrates a conveyance path of the recording material P in the image forming operation.

In the image forming operation, the driving force of the motor M1 serving as a drive source provided in the apparatus main body M is transmitted to the photosensitive drum 1, and the photosensitive drum 1 is thus rotationally driven in an arrow A1 direction (counterclockwise direction) in the drawings at a predetermined process speed. Here, the process speed corresponds to the peripheral speed (surface movement speed) of the photosensitive drum 1. The process speed in Example 1 is, for example, a speed corresponding to a rotation speed of 140 rpm of the photosensitive drum 1.

The charging roller 2 is a rotatable charging member for charging the surface of the photosensitive drum 1. The charging roller 2 is provided to be in contact with the surface of the photosensitive drum 1 at a predetermined contact pressure, and forms a charging portion ES serving as a contact portion. A predetermined charging voltage (charging bias) that is a direct current voltage is applied to the charging roller 2 from a charging voltage application circuit serving as a voltage application portion (charging voltage application portion) provided in the apparatus main body M. As a result of this, the charging roller 2 uniformly charges the surface of the photosensitive drum 1 to a predetermined potential in a predetermined polarity (negative polarity in Example 1). In Example 1, a charging voltage of −1400 V is applied to the charging roller 2 such that a pre-exposure potential VD (dark potential) that is a surface potential of the photosensitive drum 1 after the charging is −800 V. To be noted, although a direct current voltage is used as the charging voltage in Example 1, the configuration is not limited to this, and the charging voltage may be a vibrating voltage in which a direct current voltage is superimposed on an alternating voltage.

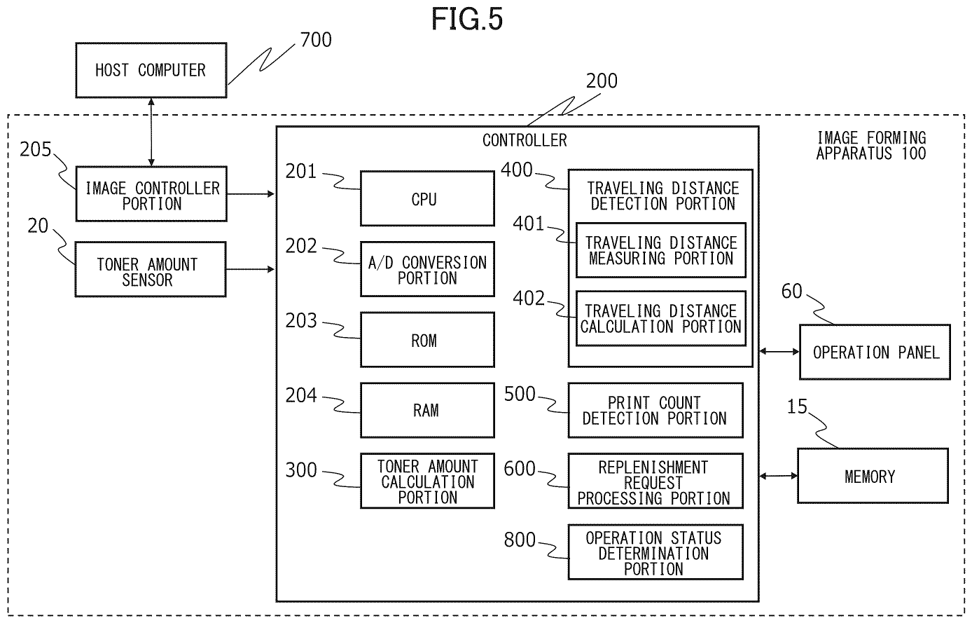

The exposing device 10 exposes the photosensitive drum 1 by radiating light in a scanning manner onto the charged surface of the photosensitive drum 1 on the basis of information (image data, print data) of an image to be formed on the recording material P. That is, the image data input to the image forming apparatus 100 from an external device is converted into a time-series digital image signal (video signal) by an image controller portion 205 (FIG. 5) provided in the image forming apparatus 100. An example of the external apparatus is a personal computer connected to the image forming apparatus 100. The exposing device 10 emits light modulated on the basis of the video signal, and exposes the surface of the photosensitive drum 1 in a scanning manner. As a result of this, an electrostatic latent image (electrostatic image) corresponding to the image data is formed on the surface of the photosensitive drum 1. In Example 1, the exposing device 10 is constituted by a laser scanner unit. In Example 1, the exposing device 10 radiates laser light onto the surface of the photosensitive drum 1 at, for example, a light amount of 0.45 J/cm² such that a post-exposure potential VL (light potential) that is a potential of the surface of the photosensitive drum 1 after the light is radiated from the exposing device 10 is −100 V.

Toner serving as developer is supplied to the photosensitive drum 1 by the developing roller 4 of the developing device 8, thus the electrostatic latent image formed on the photosensitive drum 1 is developed (visualized), and a toner image (developer image) is formed on the photosensitive drum 1. The developing roller 4 is a developer bearing member that rotates while bearing the developer in the developing container 80 (accommodation portion), and functions as a developer bearing member that forms the developer image by supplying developer to the photosensitive drum 1 (image bearing member).

The developing roller 4 forms a developing portion DS by coming into contact with the surface of the photosensitive drum 1 at a predetermined contact pressure. A toner layer of toner 3 charged to a normal polarity is formed on the developing roller 4. In Example 1, the normal polarity of the toner 3 that is the main charging polarity of the toner 3 during development is a negative polarity. A predetermined developing voltage (developing bias) that is a direct current voltage is applied to the developing roller 4 from a developing voltage application circuit serving as a developing voltage application portion provided in the apparatus main body M. As a result of this, the toner 3 attaches to the electrostatic latent image on the photosensitive drum 1 at the developing portion DS, and thus a toner image is formed on the photosensitive drum 1.

In Example 1, a developing voltage of −400 V is applied to the developing roller 4. Then, the toner 3 charged to the same polarity as the charging polarity of the photosensitive drum 1 attaches to a region (exposed portion, image portion) on the photosensitive drum 1 where the absolute value of the potential is reduced as a result of the photosensitive drum 1 being exposed after being uniformly charged (reversal development system). The charged toner 3 does not attach to the region (non-exposed portion, non-image portion) that is not exposed and where the surface potential is still the pre-exposure potential VD.

The transfer roller 13 forms a transfer portion TS by coming into contact with the photosensitive drum 1 at a predetermined contact pressure. At the transfer portion TS, the toner image formed on the photosensitive drum 1 is transferred onto the recording material P nipped and conveyed between the photosensitive drum 1 and the transfer roller 13. At the time of transfer, a predetermined transfer voltage (transfer bias) that is a direct current voltage is applied to the transfer roller 13 from a transfer voltage application circuit serving as a transfer voltage application portion. In Example 1, a transfer voltage of +1500 V is applied to the transfer roller 13.

The recording material (transfer material, recording medium, sheet) P is supplied to the transfer portion TS from a feeding portion 30. The feeding portion 30 includes a cassette 31 serving as a recording material accommodation portion, and a feed roller 32 serving as a feeding member. The recording materials P accommodated in the cassette 31 are fed one by one from the cassette 31 by the feed roller 32. A separation roller pair that separates the recording materials P from each other may be disposed at a position downstream of the feed roller 32. The fed recording material P is conveyed to the transfer portion TS by a conveyance roller pair 50 (registration roller pair) serving as a conveyance member at a timing when the toner image on the photosensitive drum 1 reaches the transfer portion TS.

The recording material P to which the toner image has been transferred when passing through the transfer portion TS is conveyed to the fixing device 14 serving as a fixing unit. The fixing device 14 fixes (melts, adheres) the toner image onto the recording material P by applying heat and pressure to the toner image on the recording material P while nipping and conveying the recording material P in the fixing nip. The recording material P to which the toner image has been fixed is discharged (output) onto the tray 40 serving as a discharge portion provided outside the apparatus main body M.

The toner (transfer residual toner) remaining on the photosensitive drum 1 without being transferred onto the recording material P at the transfer portion TS in a transfer step is removed from the photosensitive drum 1 as follows.

The surface of the photosensitive drum 1 is de-electrified by the de-electrification device 11 such that the surface potential thereof is approximately 0 V after passing through the transfer portion TS, and then enters the charging portion ES. The de-electrification device 11 executes the de-electrification by, for example, irradiating the entire surface of the photosensitive drum 1 with light. The toner (hereinafter referred to as transfer residual toner) remaining on the photosensitive drum 1 after passing through the transfer portion TS includes toner charged to the positive polarity and toner charged to the negative polarity but not having enough charges. The transfer residual toner is charged to the negative polarity by electrical discharge from the charging roller 2 at the charging portion ES.

The transfer residual toner charged to the negative polarity at the charging portion ES reaches the developing portion DS in accordance with the rotation of the photosensitive drum 1. Here, an electrostatic latent image corresponding to the image data is formed on the surface of the photosensitive drum 1 having reached the developing portion DS. Transfer residual toner attached to the non-exposed portion (non-image portion) on the photosensitive drum 1 moves to the developing roller 4 from the photosensitive drum 1 as a result of the potential difference between the pre-exposure potential VD on the photosensitive drum 1 and the developing voltage at the developing portion DS, and is thus collected by the developing device 8. To be noted, the toner collected by the developing device 8 is mixed with the toner in the developing device 8, and is used for image formation again.

As described above, the image forming apparatus 100 of the present example has a configuration (simultaneous development/cleaning system) in which the transfer residual toner on the photosensitive drum 1 not transferred onto the recording material P serving as a transfer receiving member at the transfer portion TS is collected into the developing container 80 by the developing roller 4. In addition, the image forming apparatus 100 of the present example has a cleanerless system not including a cleaning member for removing the transfer residual toner from the photosensitive drum 1.

In the simultaneous development/cleaning system, since the transfer residual toner is collected into the developing container 80 and used for image formation repeatedly, there is a tendency that the proportion of deteriorated toner gradually increases. In the present example, deterioration of toner can be suppressed by control that will be described later, and thus occurrence of image fogging caused by the deteriorated toner can be reduced. To be noted, the control of the present example is also applicable to an image forming apparatus that removes the transfer residual toner by a cleaning member.

In contrast, the transfer residual toner that has already attached to the exposed portion (image portion) on the photosensitive drum 1 when reaching the developing portion DS does not move from the photosensitive drum 1 to the developing roller 4 at the developing portion DS. This is because the post-exposure potential is a potential in a polarity (positive polarity) opposite to the normal polarity of the toner 3 with respect to the potential (developing voltage) of the developing roller 4 and the transfer residual toner charged to the normal polarity stays in the exposed portion. The transfer residual toner remaining in the exposed portion becomes part of the toner image formed in the developing portion DS, and is removed from the photosensitive drum 1 by being transferred onto the recording material P in the transfer portion TS.

In addition, foreign matter (hereinafter collectively referred to as paper dust) such as paper dust fiber generated from the recording material P and filler can attach to the photosensitive drum 1. The brush member 12 functions as a paper dust collecting member that collects the paper dust. The brush member 12 is disposed to come into contact with the photosensitive drum 1 at a position downstream of the transfer portion TS and upstream of the charging portion ES in the rotation direction of the photosensitive drum 1. The brush member 12 rubs the surface of the photosensitive drum 1 in accordance with the rotation of the photosensitive drum 1, and thus brushes off and removes the paper dust on the photosensitive drum 1.

To be noted, the image forming apparatus 100 according to Example 1 does not include a developing contact/separation mechanism capable of bringing the developing roller 4 and the photosensitive drum 1 into contact with and out of contact from each other, and the developing roller 4 and the photosensitive drum 1 are always in contact with each other. In addition, in Example 1, the voltage application portion is configured to be capable of applying a voltage of a polarity opposite to the negative polarity to the developing roller 4 from a power source for developing voltage application. That is, in the case of not executing development, transfer of the toner to the photosensitive drum 1 can be suppressed by applying a voltage of a positive polarity opposite to the normal polarity of the toner to the developing roller 4.

The image forming apparatus 100 may include a developing contact/separation mechanism. In this case, transfer of toner to the photosensitive drum 1 can be suppressed by separating the developing roller 4 and the photosensitive drum 1 from each other when not executing development.

### Details of Constituents of Process Unit

Next, details of the constituents of the process unit 9 in Example 1 will be described. The configuration of each element described below is merely an example, and can be modified in accordance with the specific configuration of the image forming apparatus 100.

### Photosensitive Drum

The photosensitive drum 1 of Example 1 includes a cylindrical conductive drum and a photosensitive layer formed from organic photoconductor (OPC) on the outer peripheral surface of the conductive drum. The photosensitive drum 1 may be a stiff cylindrical member manufactured by, for example, applying a resistor layer, an undercoat layer, a charge-generating layer, and a charge transport layer on the outer peripheral surface of an aluminum cylinder having a diameter of 24 mm in this order. The thickness of the charge transport layer is, for example, 22 m.

### Charging Roller

The charging roller 2 of Example 1 is manufactured by, for example, applying a base layer of hydrin rubber and a surface layer of urethane in this order on the outer peripheral surface of a core metal having a diameter of 6 mm such that the outer diameter thereof is 12 mm. In addition, the electrical resistance value of the charging roller 2 is 1×10⁶Ω or less. The hardness of the charging roller 2 is 40° as measured by an Asker C rubber hardness meter manufactured by Kobunshi Keiki Co., Ltd.

### Exposing Device

The exposing device 10 of Example 1 is a laser scanner unit capable of changing the light amount of the laser light radiated onto the surface of the photosensitive drum 1. The wavelength of the laser light emitted from the exposing device 10 is 800 nm. In addition, the light source of the exposing device 10 is a semiconductor laser. The exposing device 10 includes a semiconductor laser and a scanning optical system that guides the light emitted from the laser light source to the photosensitive drum 1. To be noted, the exposing device 10 may be a light-emitting diode (LED) exposing device including an LED as a light source.

### Transfer Roller

The transfer roller 13 of Example 1 includes a core metal having a diameter of 6 mm and a base layer of ion-conductive sponge formed such that the outer diameter is 15 mm. In addition, the electrical resistance value of the transfer roller 13 is 4×10⁷Ω at a temperature of 22° C. The hardness of the transfer roller 13 is 30° as measured by an Asker C rubber hardness meter manufactured by Kobunshi Keiki Co., Ltd.

### Developing Device

The developing device 8 of Example 1 includes the developing container 80, the developing roller 4, a supply roller 5 serving as a supply member, a developing blade 6 serving as a regulation member, and an agitation member 7.

The developing device 8 of Example 1 is a one-component contact developing device using a non-magnetic one-component developer (toner) as the developer. A developing chamber 8b and a toner accommodation chamber 8a each serving as a developer accommodation chamber that accommodates developer are formed in the developing container 80. The developing container 80 is an example of an accommodation portion (developer accommodation portion) that accommodates developer. The developing container 80 also functions as a frame body (developing frame body) of the developing device 8. The developing chamber 8b and the toner accommodation chamber 8a communicate with each other through an opening portion.

The developing roller 4, the supply roller 5, and the developing blade 6 are provided in the developing chamber 8b. The developing roller 4 is rotatably disposed in the opening portion of the developing container 80 (opening portion of the developing chamber 8b), and conveys the toner 3 from the inside to the outside of the developing chamber 8b (developing container 80) by rotating while bearing the toner 3. The supply roller 5 supplies the toner 3 in the developing chamber 8b to the developing roller 4. The developing blade 6 regulates the amount of toner (coating thickness of toner) borne on the developing roller 4 and supplied to the developing portion DS. In addition, the developing blade 6 increases the charge amount of the toner 3 by rubbing the toner 3 on the developing roller 4. A voltage of the same polarity as the normal polarity of the toner 3 may be applied to the developing blade 6.

The toner accommodation chamber 8a accommodates the toner 3 serving as a developer. In addition, the agitation member 7 is disposed in the toner accommodation chamber 8a. The agitation member 7 conveys the toner 3 from the toner accommodation chamber 8a to the developing chamber 8b while agitating the toner 3 in the toner accommodation chamber 8a.

To be noted, although the developing device 8 of Example 1 employs a contact developing system in which the photosensitive drum 1 and the developing roller 4 are disposed to be in contact with each other, the configuration is not limited to this. The developing device 8 may employ a two-component developing system using a two-component developer, or a non-contact developing system in which the photosensitive drum 1 and the developing roller 4 are disposed to oppose each other with a predetermined gap therebetween.

The developing roller 4 of Example 1 is manufactured by applying a base layer of silicone rubber and a surface layer of urethane rubber in this order on the outer peripheral surface of a core metal having a diameter of 6 mm such that the outer diameter thereof is 15 mm. In addition, the electrical resistance value of the developing roller 4 is 1×10⁴ to 1×10¹²Ω.

The supply roller 5 of Example 1 is a conductive elastic sponge roller in which a foam layer is formed on the outer peripheral surface of a core metal having a diameter of 6 mm. In addition, the electrical resistance value of the supply roller 5 is 1×10⁴ to 1×10⁸Ω, and the hardness thereof is 200 gf. To be noted, the hardness of the supply roller 5 is a value obtained by measuring the load in the case of sticking a flat plate having a longitudinal width of 50 mm into the surface of the supply roller 5 by 1 mm.

The developing blade 6 of Example 1 is a thin and elongated plate-like member having the rotation axis direction of the developing roller 4 as a longitudinal direction. The developing blade 6 may be a metal plate (for example, steel use stainless: SUS metal plate) having a thickness of 0.1 mm and a predetermined length in the longitudinal direction and a short-side direction approximately orthogonal to the longitudinal direction. This developing blade 6 is disposed such that a free end thereof in the short-side direction is directed upstream in the rotation direction of the developing roller 4 and a side surface near the free end is in contact with the surface of the developing roller 4 along the longitudinal direction. An SUS metal plate whose distal end (free end) is cut from the contact surface side with the developing roller 4 is used as the developing blade 6. The distal end portion of the developing blade 6 is bent in the cutting direction by the cutting, and the bend amount of the distal end of the developing blade 6 corresponding to the curvature radius is 0.02 mm.

The movement of the toner 3 in the developing device 8 that is driving will be described. A driving force is transmitted to the developing device 8 from the motor M1 serving as a drive source provided in the apparatus main body M. As a result of this, the developing roller 4 rotates in an arrow A2 direction (clockwise direction) in the drawings, the supply roller 5 rotates in an arrow A3 direction (clockwise direction) in the drawings, and the agitation member 7 rotates in an arrow A4 direction (counterclockwise direction) in the drawings. To be noted, the drive source of the photosensitive drum 1 and the drive source of each rotary member (developing roller 4, supply roller 5, and agitation member 7) of the developing device 8 may be the same. In addition, the drive source of each rotary member of the developing device 8 and the drive source that rotationally drives each rotary member (fixing roller, pressurizing roller) of the fixing device 14 may be the same.

As a result of the rotation of the agitation member 7 in the toner accommodation chamber 8a, the toner 3 in the toner accommodation chamber 8a is agitated and conveyed toward the supply roller 5 in the developing chamber 8b. The toner 3 held by the foam layer of the supply roller 5 is delivered to the contact portion between the developing roller 4 and the supply roller 5 by the rotation of the supply roller 5. The toner 3 having reached the contact portion is rubbed by the surface of the developing roller 4 and the surface of the supply roller 5 that move in opposite directions in the contact portion, and part of the toner attaches to the surface of the developing roller 4.

The toner 3 attached to the surface of the developing roller 4 is delivered to the contact portion between the developing roller 4 and the developing blade 6 in accordance with the rotation of the developing roller 4. The developing blade 6 regulates the amount of the toner 3 attached to the surface of the developing roller 4 and thus forms a uniform thin layer, and frictionally charges the toner 3. The toner 3 shaped into a thin layer is delivered to the contact portion (developing portion DS) between the developing roller 4 and the photosensitive drum 1 in accordance with the rotation of the developing roller 4, and is used for development of the electrostatic latent image formed on the photosensitive drum 1. The toner 3 remaining on the surface of the developing roller 4 without being used for development is conveyed to the contact portion between the developing roller 4 and the supply roller 5, and is removed from the surface of the developing roller 4 by the supply roller 5. The toner 3 that has been removed is delivered into the toner accommodation chamber 8a, and is agitated and mixed with the toner 3 in the toner accommodation chamber 8a.

### Toner Replenishment Configuration

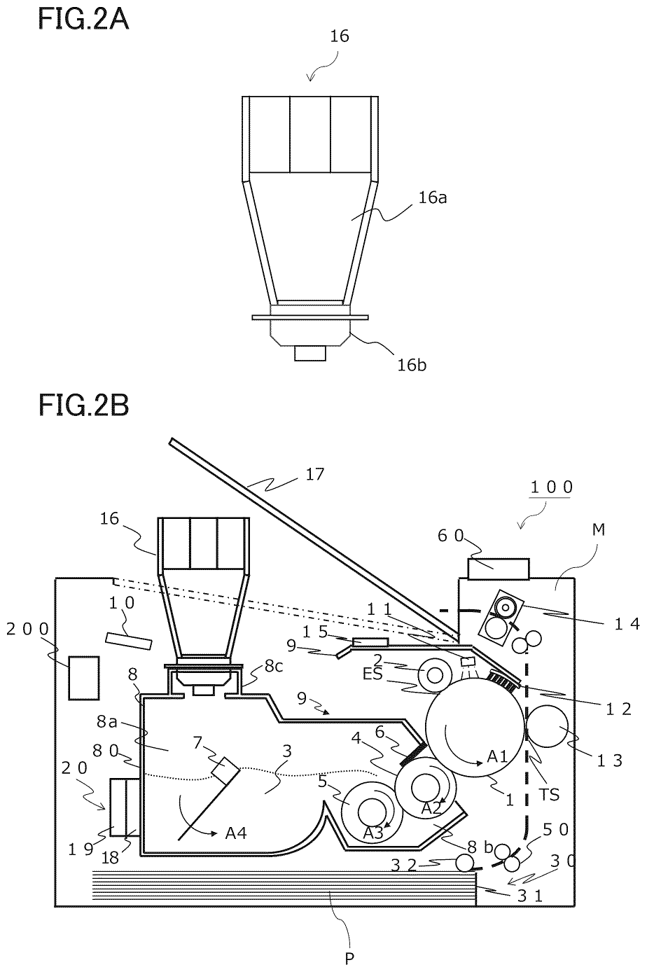

Next, a configuration related to toner replenishment of the developing device 8 in the present example will be described. FIG. 2A is a schematic front view of a toner pack 16 serving as a replenishment container in the present example. In addition, FIG. 2B is a schematic section view illustrating a state in which the toner pack 16 is attached to the developing container 80 of the developing device 8.

As illustrated in FIG. 1, a replenishment protrusion portion 8c is formed in the developing container 80. The replenishment protrusion portion 8c is an attachment portion configured such that the toner pack 16 serving as a replenishment container is attachable thereto and detachable therefrom. The replenishment protrusion portion 8c is hollow inside, and is formed to communicate with the toner accommodation chamber 8a via a replenishment port 8d. Atop cover 17 is openably and closably provided in an upper portion of the apparatus main body M. To be noted, the upper surface of the top cover 17 constitutes the tray 40 described above.

As illustrated in FIG. 2A, in the present example, the toner pack 16 includes a bag 16a that is formed from plastics and is easily deformable, and a coupling portion 16b provided at one end portion of the bag 16a. The inside of the bag 16a and the inside of the coupling portion 16b communicate with each other. As illustrated in FIG. 2B, the image forming apparatus 100 is configured such that the replenishment protrusion portion 8c is exposed to the outside by opening the top cover 17 upward. The toner pack 16 can be attached to the replenishment protrusion portion 8c from the upper side in the state in which the replenishment protrusion portion 8c is exposed.

When the toner pack 16 is attached to the replenishment protrusion portion 8c, it becomes possible to replenish the toner accommodation chamber 8a with toner from the toner pack 16. The toner pack 16 is attached to the replenishment protrusion portion 8c in a state in which the coupling portion 16b is coupled to the replenishment protrusion portion 8c after the top cover 17 is opened. In addition, the toner pack 16 is attached to the replenishment protrusion portion 8c in a state in which at least part of the bag 16a including an end portion of the bag 16a on the opposite side to the coupling portion 16b is exposed to the outside of the image forming apparatus 100.

When the toner pack 16 is attached to the replenishment protrusion portion 8c, the inside of the toner pack 16 and the inside of the replenishment protrusion portion 8c communicate with each other. Then, the toner stored in the toner pack 16 is discharged into the replenishment protrusion portion 8c through an opening portion provided in the coupling portion 16b of the toner pack 16, and this toner is supplied into the toner accommodation chamber 8a from the replenishment protrusion portion 8c through the replenishment port 8d.

To be noted, although the replenishment container includes a bag that is formed from plastics and that is easily deformable in the present example, the configuration is not limited to this. For example, the replenishment container may include a bottle container having an approximate conical shape or an approximate cylindrical shape. In addition, for example, the replenishment container may include a paper container formed from paper. In addition, regarding the method to discharge toner from the replenishment container, in the case where the replenishment container is the toner pack 16 as in the present example or a paper container, the operator may squeeze the container with fingers, and it may be preferable that the operator vibrates the container by hitting the container or the like in the case where the replenishment container is a bottle container. In addition, a discharge mechanism may be provided in the bottle container to discharge toner from the replenishment container. In addition, the discharge mechanism may be configured to engage with a driving mechanism provided in the apparatus main body M of the image forming apparatus 100 and receive drive from the driving mechanism.

In addition, to suppress leakage of toner from the replenishment container, a shutter member of a rotary type or a slide type may be provided in the replenishment container. In addition, the shutter member may be configured to be broken by being attached to the replenishment port of the developing device 8, or may have a detachable lid structure such as a sticker. In addition, a shutter member movable to a closed position where the shutter member closes the replenishment port 8d to suppress entrance of foreign matter into the developing container 80, and an open position where the shutter member opens the replenishment port 8d may be provided in the replenishment protrusion portion 8c.

The image forming apparatus 100 in the present example employs an external replenishment system (direct replenishment system) in which the developing container 80 in the apparatus can be replenished with toner from the outside of the apparatus by using a replenishment container. That is, the operator replenishes the developing container 80 in the apparatus with toner by attaching the toner pack 16 serving as a replenishment container to the replenishment protrusion portion 8c (attachment portion) exposed to the outside of the image forming apparatus 100.

Instead of the external replenishment system, a system (successive replenishment system) in which a replenishment container such as a toner bottle is attached to the inside of the image forming apparatus 100 and replenishment is executed successively in accordance with the decrease in the toner amount in the developing container 80 is used in some cases. In the external replenishment system, the ratio of fresh toner in the developing container 80 increases discontinuously, and the average degree of deterioration of the toner in the developing container 80 changes quickly as compared with the successive replenishment system. That is, in the external replenishment system, image fogging caused by deterioration of toner is not likely to occur immediately after toner replenishment. To be noted, the developing container 80 before toner replenishment includes deteriorated toner. Therefore, part of the toner in the developing container 80 has already deteriorated even immediately after toner replenishment, and the ratio of the deteriorated toner to the toner present in the developing container 80 gradually increases each time toner replenishment is repeated. In the case of using the external replenishment system, it may be preferable to take a measure to reduce the occurrence of image fogging in consideration of the characteristics described above.

In addition, it has been disclosed that the developing container 80 is replenished with a large amount of fresh toner in one time in the case of the external replenishment system, but the developing container 80 is replenished with a large amount of fresh toner in one time also in a form in which the replenishment container is temporarily attached to the inside of the image forming apparatus 100 and detached when the replenishment is completed. For example, in a state in which the toner pack 16 is attached to the replenishment protrusion portion 8c, the position of the replenishment protrusion portion 8c may be changed such that the entirety of the toner pack 16 is inside the outer shape of the apparatus main body M. Also in such a case, it may be preferable to take a measure in consideration of the characteristics that the average degree of deterioration of toner in the developing container 80 quickly changes by the replenishment operation.

### Toner Amount Sensor

Next, the toner amount sensor 20 serving as a developer amount detection portion that detects the toner amount (toner remainder amount) in the developing device 8 will be described. The toner amount sensor 20 of the present example is an optical sensor including a light guiding member 18 and a sensor portion 19.

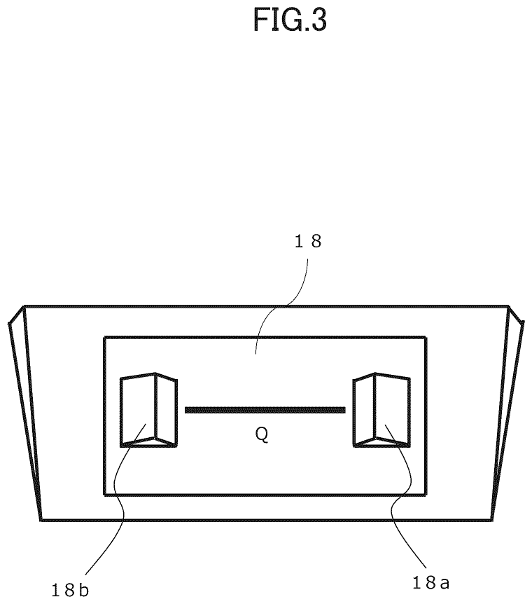

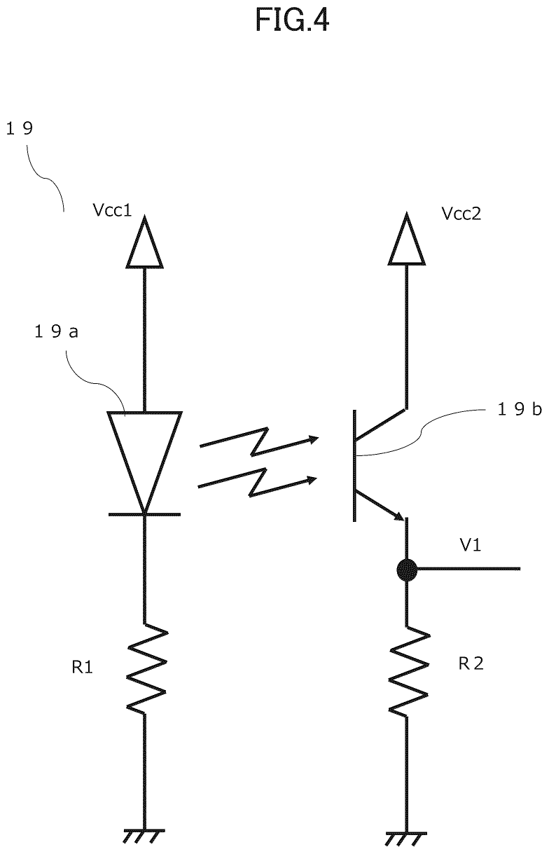

FIG. 3 is a schematic front view of the light guiding member 18 in Example 1. FIG. 4 is a circuit diagram illustrating a part of the sensor portion 19 in Example 1. FIG. 5 is a block diagram illustrating a control system of the image forming apparatus 100 of Example 1.

As illustrated in FIG. 1, the light guiding member 18 is attached to the developing container 80 of the developing device 8. As illustrated in FIG. 3, the light guiding member 18 includes an emitting-side light guiding portion 18a and a receiving-side light guiding portion 18b. The emitting-side light guiding portion 18a guides light emitted from a light emitting element 19a of the sensor portion 19 that will be described later into the developing container 80. The receiving-side light guiding portion 18b guides light incident through the emitting-side light guiding portion 18a and a spatial light path Q in the developing container 80 to a light receiving element 19b of the sensor portion 19 that will be described later.

In addition, as illustrated in FIG. 1, the sensor portion 19 is attached to the developing device 8. As illustrated in FIG. 4, the sensor portion 19 includes the light emitting element 19a serving as a light emitting portion that emits light, and a light receiving element 19b serving as a light receiving portion that receives light emitted from the light emitting element 19a. The sensor portion 19 is a circuit board on which the light emitting element 19a and the light receiving element 19b are mounted. In Example 1, an LED is used as the light emitting element 19a, and a photo-transistor is used as the light receiving element 19b. This photo-transistor is turned on by the light from the LED. In addition, a cable connector is provided on the circuit board. The sensor portion 19 is electrically connected to the controller 200 provided in the apparatus main body M of the image forming apparatus 100 via the cable connector.

Next, the placement of the toner amount sensor 20 in Example 1 will be described. As illustrated in FIG. 1, the toner amount sensor 20 is disposed on a side surface of the toner accommodation chamber 8a of the developing container 80. The toner amount sensor 20 is disposed at a center portion of the toner accommodation chamber 8a (center portion of the developing container 80) in the longitudinal direction of the developing container 80. To be noted, the longitudinal direction of the developing container 80 or the longitudinal direction of the developing device 8 refers to the direction of the rotation axis of the developing roller 4.

There is a possibility that the toner in the toner accommodation chamber 8a is biased toward a portion of the toner accommodation chamber 8a in the longitudinal direction, but the amount of the toner in the center portion of the toner accommodation chamber 8a is not likely to be greatly affected by the bias of the toner. Therefore, by providing the toner amount sensor 20 in the center portion of the toner accommodation chamber 8a, the influence of the biased distribution of the toner can be suppressed, and the toner amount T in the developing container 80 can be detected more accurately.

Next, the method for detecting the toner amount T by the toner amount sensor 20 will be described. Power is supplied to the toner amount sensor 20 from a power source provided in the apparatus main body M. A switch is provided between the light emitting element 19a of FIG. 4 and a power source voltage Vcc1, and as a result of turning this switch on, a voltage is applied to the light emitting element 19a from the power source voltage Vcc1, and thus the light emitting element 19a takes a conducting state (light emitting state). Meanwhile, a switch is also provided between the light receiving element 19b and a power source voltage Vcc2, and as a result of turning this switch on, the light receiving element 19b takes a conducting state, and a current corresponding to the amount of incident light flows in the light receiving element 19b.

The light emitting element 19a is connected to the power source voltage Vcc1 and a current restriction resistor R1, and the light emitting element 19a emits light by a current determined by the current restriction resistor R1. The light emitted from the light emitting element 19a passes through the spatial light path Q and is received by the light receiving element 19b. When the spatial light path Q is blocked by the toner in the developing container 80, the light does not reach the light receiving element 19b.

A collector terminal of the light receiving element 19b is connected to the power source voltage Vcc2, and an emitter terminal of the light receiving element 19b is connected to a detection resistor R2. The light receiving element 19b that is a photo-transistor receives light emitted from the light emitting element 19a, and outputs a signal (current) corresponding to the amount of received light. This signal is converted into a voltage by the detection resistor R2, and is input to an A/D conversion portion 202 (FIG. 5) of the controller 200. That is, the signal output by the light receiving element 19b changes in accordance with the toner amount T in the developing container 80.

A toner amount calculation portion 300 (FIG. 5) of the controller 200 determines whether or not the light receiving element 19b receives light, on the basis of the level of the voltage that has been input to the controller 200 by the toner amount sensor 20 and converted into a digital signal by the A/D conversion portion 202. Then, the toner amount calculation portion 300 calculates the length of time for which light is detected by the toner amount sensor 20 when the toner in the developing container 80 is agitated for a predetermined time by the agitation member 7. Toner amount determination information for determining (calculating, predicting, estimating) the toner amount T is stored in a read-only memory (ROM) 203 (FIG. 5) of the controller 200 in advance. The toner amount determination information is, for example, a table representing the relationship between the length of time for which light is detected by the toner amount sensor 20 and the toner amount T. Then, the toner amount calculation portion 300 calculates the toner amount T in the developing container 80 on the basis of the length of the time for which light is detected by the toner amount sensor 20, by using the toner amount determination information.

More specifically, the spatial light path Q in the toner amount sensor 20 is set at a position intersecting with the rotation trajectory of the agitation member 7 as viewed in the rotation axis direction of the agitation member 7 in the toner accommodation chamber 8a. Further, time for which the light in the spatial light path Q is blocked by the toner conveyed by the agitation member 7 while the agitation member 7 rotates once, that is, time in which the light receiving element 19b does not detect the light from the light emitting element 19a changes in accordance with the toner amount in the developing container 80. In addition, the intensity of received light in the light receiving element 19b also changes in accordance with the toner amount in the developing container 80.

That is, when the toner amount in the developing container 80 is small, the time for which the spatial light path Q is blocked by the toner 3 is short, therefore the time for which light is received by the light receiving element 19b is long, and the intensity of the light received by the light receiving element 19b is high. In contrast, when the toner amount in the developing container 80 is large, conversely the time for which the light is received by the light receiving element 19b is short, and the intensity of the light received by the light receiving element 19b is low. Therefore, the controller 200 can determine the toner amount T in the developing container 80 on the basis of a signal of the toner amount sensor 20 that changes in accordance with the light receiving time and/or the received light intensity of the light receiving element 19b.

The toner amount calculation portion 300 stores, as a current toner amount TO and in the memory 15 (FIG. 5), a toner amount T in the developing container 80 calculated on the basis of the detection result of the toner amount sensor 20. To be noted, in Example 1, the value of the toner amount stored in the developing container 80 in a brand-new state (start of use, unused state) of the developing device 8 (process unit 9) is stored in the memory 15 in advance as an initial toner amount.

In Example 1, the toner amount T is calculated by the toner amount calculation portion 300 by using the toner amount sensor 20 immediately after the image forming job is finished, and a toner amount T1 at the end of the job is detected. The toner amount calculation portion 300 updates the value of the current toner amount T0 in the case where the value of the toner amount T1 at the end of the job is smaller than the current toner amount T0 stored in the memory 15. That is, in the case where T0>T1 holds, the controller 200 replaces the value of the current toner amount T0 stored in the memory 15 by T1.

The toner amount calculation portion 300 may calculate the toner amount T in the developing container 80 on the basis of the signal of the toner amount sensor 20 (signal of light receiving element 19b) while the image forming operation is executed.

To be noted, the detection method or estimation method for the toner amount is not limited to the optical detection method described above, and a known detection method/estimation method can be employed. For example, a toner remainder amount sensor of a capacitance system may be used. In this case, two or more metal plates or conductive resin sheets extending in the longitudinal direction of the developing roller 4 are disposed on the inner wall of the developing container 80 serving as a frame member. The toner amount calculation portion 300 can detect/estimate the toner amount in the developing container 80 by measuring the capacitance between the metal plates or conductive resin sheets. Alternatively, a load cell that supports the developing device 8 from below may be used as a toner remainder amount sensor. In this case, the toner amount calculation portion 300 can calculate the toner amount in the developing container 80 by subtracting the weight of the developing device 8 in a state in which the developing container 80 is empty from the weight measured by the load cell. In addition, although the toner amount is detected by one sensor of an optical detection system in the present example, the toner amount may be detected by using a plurality of sensors.

### Control Configuration

As illustrated in FIG. 5, the apparatus main body M of the image forming apparatus 100 is provided with the controller 200 serving as a control circuit that controls the image forming apparatus 100. The controller 200 includes a central processing unit (CPU) 201 that executes arithmetic processing, the A/D conversion portion 202, the ROM 203 and a random access memory (RAM) 204 serving as a storage portion (storage medium), and an input/output circuit. The CPU 201 is an execution portion that executes a program for controlling the image forming apparatus 100. The A/D conversion portion 202 converts the analog signal input to the controller 200 into a digital signal. The ROM 203 stores a control program, a data table obtained in advance, and the like. The RAM 204 stores information input to the controller 200, information detected by each sensor, calculation results, and the like. The image controller portion 205 (video controller) is mutually communicable with a host computer 700 that is an external apparatus, and the controller 200.

The controller 200 is electrically connected to each portion (each driving device, each power source, each sensor, and the like) of the image forming apparatus 100. The controller 200 controls the operation of each portion of the image forming apparatus 100 by communicating with the portion. The controller 200 controls each portion of the image forming apparatus 100 and executes the image forming operation on the basis of a signal (image formation start signal, image signal) input from an external apparatus (not illustrated) such as a personal computer in accordance with the operation by the operator.

In addition, the controller 200 includes a toner amount calculation portion 300, a traveling distance detection portion 400, a print count detection portion 500, a replenishment request processing portion 600, and an operation status determination portion 800. The functions of these portions may be realized by the CPU 201 executing a program stored in the ROM 203. In this case, the CPU 201 functions as the toner amount calculation portion 300, the traveling distance detection portion 400, the print count detection portion 500, and/or the replenishment request processing portion 600. In addition, the function of each of these portions may be realized by a dedicated chip such as an application specific integrated circuit (ASIC).

The toner amount calculation portion 300 calculates the toner amount T (toner remainder amount) in the developing container 80 on the basis of the detection result of the toner amount sensor 20 as described above.

The traveling distance detection portion 400 detects the traveling distance of the developing roller 4. The traveling distance of the developing roller 4 is the movement distance of the surface of the developing roller 4 according to the rotation of the developing roller 4. As will be described later, the traveling distance detection portion 400 of the present example detects increase in the traveling distance of the developing roller 4 by a predetermined amount Ru, and calculates the traveling distance of the developing roller 4 on the basis of the number of times of the detection.

To be noted, the target that is directly detected by the traveling distance detection portion 400 does not need to be the traveling distance itself of the developing roller 4, and it suffices as long as an amount that increases proportionally to the increase in the movement distance of the surface of the developing roller 4 according to the rotation of the developing roller 4 is detected. That is, the traveling distance of the developing roller 4 detected by the traveling distance detection portion 400 (including R0, Ry, and Rn described later) may be a value related to the cumulative traveling distance of the developing roller 4. For example, the traveling distance detection portion 400 may count the number of rotations of the developing roller 4. In this case, for example, the traveling distance detection portion 400 and the controller 200 may use the count value of the number of rotations of the developing roller 4 as a variable indicating the “traveling distance of the developing roller 4”. For example, the traveling distance detection portion 400 may count the number of rotations of the developing roller 4 by using a sensor that outputs an ON signal each time the developing roller 4 passes a predetermined rotational phase. In addition, the traveling distance detection portion 400 may count the number of rotations of the developing roller 4 on the basis of the rotation amount of the motor M1 that drives the developing roller 4.

In addition, for example, the traveling distance detection portion 400 may count the number of rotations of a coupling provided in the process unit 9 to receive a driving force of the motor M1 from a body-side coupling of the apparatus main body M and transmit the driving force to the developing roller 4. In the case where the driving speed of the developing roller 4 is constant, the traveling distance detection portion 400 may count the rotation time of the motor M1 driving the developing roller 4.

In the description below, a cumulative value of the traveling distance of the developing roller 4 will be referred to as a cumulative traveling distance R0. The memory 15 stores the value of the cumulative traveling distance R0 based on the traveling distance of the developing roller 4 detected by the traveling distance detection portion 400. To be noted, when the developing device 8 is brand-new, R0 is 0.

The operation for the operator to replenish the developing container 80 with toner by using the replenishment container will be referred to as a replenishment operation. The replenishment operation is a series of operations in which the developing container 80 (accommodation portion) is replenished with developer through the replenishment port 8d from the toner pack 16 (replenishment container) attached to the replenishment protrusion portion 8c (attachment portion) and then the toner pack 16 is detached from the replenishment protrusion portion 8c.

A cumulative value of the traveling distance of the developing roller 4 since the previous replenishment operation will be referred to as an inter-replenishment traveling distance Ry. The memory 15 stores the inter-replenishment traveling distance Ry in addition to the cumulative traveling distance R0. The replenishment traveling distance Ry is 0 when the developing device 8 is brand-new. In addition, the inter-replenishment traveling distance Ry is reset in the case where the replenishment operation is executed (when completion of the replenishment operation is detected). To be noted, the cumulative traveling distance R0 is not reset even when the replenishment operation is executed. That is, Ry is 0 and R0 is not 0 in a state after the start of usage of the developing device 8 and immediately after the replenishment operation.

The print count detection portion 500 detects a cumulative print count N0 (cumulative count of image formation, cumulative execution number of image forming operation) that is a number of images that have been formed on recording materials P by the image forming operation. The print count detection portion 500 counts the number of times the image forming operation has been executed since the brand-new state as the cumulative print count N0. The memory 15 stores the cumulative print count N0 counted by the print count detection portion 500. To be noted, NO is 0 when the developing device 8 is brand-new.

The replenishment request processing portion 600 executes a replenishment request notification to prompt the operator to execute the replenishment operation on the basis of the toner amount T calculated by the toner amount calculation portion 300. The replenishment request processing portion 600 displays, as the replenishment request notification, information to prompt the operator to execute the replenishment operation on an operation panel 60. In addition, the replenishment request processing portion 600 detects execution (completion) of the replenishment operation on the basis of a signal input from the operation panel 60 in accordance with an operation by the operator.

The method of the replenishment request notification may be, for example, issuing a command to notify the information prompting the replenishment operation to an external computer communicably connected to the image forming apparatus 100. In addition, instead of the configuration of detecting the execution of the replenishment operation on the basis of the operation on the operation panel 60, the replenishment request processing portion 600 may detect the execution of the replenishment operation on the basis of the detection result of the toner amount T by the toner amount calculation portion 300.

The cumulative number of the replenishment operations executed until the current time since the brand-new state of the developing device 8 will be referred to as a cumulative replenishment count H0. H0 is 0 when the developing device 8 is brand-new. The replenishment request processing portion 600 counts the value of H0, and increases the value of H0 by 1 each time the replenishment operation is executed. The memory 15 stores the value of the cumulative replenishment count H0 counted by the replenishment request processing portion 600.

The operation status determination portion 800 determines whether the current operation status of the image forming apparatus 100 is during execution of the image forming operation, during execution of a non-image-forming operation, during execution of a predetermined non-image-forming operation, or the like. The non-image-forming operation and the predetermined-non-image-forming operation will be described later. In addition, the operation status determination portion 800 measures the inter-replenishment specific traveling distance Rn that is a traveling distance of the developing roller 4 during the execution of the predetermined non-image-forming operation.

The inter-replenishment specific traveling distance Rn is an amount indicating a cumulative value of the traveling distance of the developing roller 4 resulting from rotational driving of the developing roller 4 during the predetermined non-image-forming operation since the completion of the previous replenishment operation. The inter-replenishment specific traveling distance Rn is 0 when the developing device 8 is brand-new. In addition, the inter-replenishment specific traveling distance Rn is reset in the case where the replenishment operation is executed (when completion of the replenishment operation is detected).

The rotation period of the developing roller 4 corresponding to the inter-replenishment specific traveling distance Rn is part of the rotation period of the developing roller 4 corresponding to the inter-replenishment traveling distance Ry described above. The inter-replenishment traveling distance Ry described above also includes the increase in the traveling distance originating from the rotation of the developing roller 4 in the image forming operation.

The operation status determination portion 800 measures the inter-replenishment specific traveling distance Rn on the basis of the detection result of the traveling distance detection portion 400 in the case of determining that the current operation status of the image forming apparatus 100 is the predetermined non-image-forming operation. The memory 15 stores the value of the inter-replenishment specific traveling distance Rn based on the measurement result of the operation status determination portion 800.

### Non-Image-Forming Operation

Next, the non-image-forming operation and the predetermined non-image-forming operation in Example 1 will be described. In the present embodiment, the “non-image-forming operation” is an operation that the image forming apparatus 100 executes when the image forming operation is not executed (when image is not being formed). That is, the non-image-forming operation is an operation that does not form an image on the recording material. In addition, in the present embodiment, the “predetermined non-image-forming operation” is a predetermined operation that includes rotating the developing roller 4 (developer bearing member) and that is not necessary for executing the image forming operation. That is, the controller 200 is capable of executing the image forming operation regardless of whether or not the predetermined non-image-forming operation is to be executed.

The controller 200 of Example 1 executes two kinds of operations that are a pre-start operation and a toner remainder amount detection operation, as the predetermined non-image-forming operation.

The pre-start operation is a preliminary operation of the image forming operation that is executed before an image formation start instruction (second instruction that will be described later). As will be described in detail later, the pre-start operation is an operation of heating (pre-heating) the fixing device 14 while rotating the motor M1 before receiving the second instruction, in response to the controller 200 having received an image formation preparation instruction (first instruction that will be described later) from the image controller portion 205 (video controller). As a result of the execution of the pre-start operation, the waiting time (FPOT) before the first image is output is shortened as compared with, for example, a case where heating of the fixing device 14 is not started until the image formation start instruction (second instruction) is received. Here, FPOT stands for first print out time.

The toner remainder amount detection operation is an operation of detecting the toner amount in the developing container 80 by the toner amount sensor 20 while rotating the motor M1 after the image forming operation is finished. As described above, the influence of the biased distribution of the toner on the detection accuracy of the toner amount can be reduced by providing the toner amount sensor 20 at a center portion of the toner accommodation chamber 8a in the longitudinal direction. However, in the case where the bias of the usage amount of the toner in the longitudinal direction in the image forming operation is large, there is a possibility that there is an influence of the biased distribution of the toner. By executing a toner remainder amount detection operation that will be described later, the influence of the biased distribution can be reduced, and the detection accuracy of the toner amount can be improved even in the case where the bias of the usage amount of the toner is large.

In addition, the controller 200 of Example 1 executes a pre-rotation operation and a post-rotation operation following the image forming operation as non-image-forming operations other than the predetermined non-image-forming operation.

The pre-rotation operation is a preliminary operation for the image forming operation. In the pre-rotation operation, the controller 200 starts the driving of each rotary member of the process unit 9 and the fixing device 14 by the motor M1, and starts heating the fixing device 14.

Whereas the pre-start operation is executed before the image formation start instruction (second instruction) on the basis of the image formation preparation instruction (first instruction), the pre-rotation operation is executed on the basis of the image formation start instruction (second instruction). In addition, whereas the controller 200 does not start the image forming operation until the image formation start instruction (second instruction) is received after the pre-start operation is started, the image forming operation is started sequentially from the end of the pre-rotation operation after the pre-rotation operation is started. That is, the controller 200 is configured to execute the pre-start operation as a first preliminary operation and the pre-rotation operation as a second preliminary operation.

The post-rotation operation is an organizing operation after the image forming operation. In the post-rotation operation, for example, processing to finish application of the developing voltage and the charging voltage is executed.

To be noted, as will be described later, there is a case where the post-rotation operation is executed also in the case where timeout or a cancelling instruction occurs after the start of the pre-start operation and the pre-start operation is stopped (stopped temporarily or terminated). The post-rotation operation following the pre-start operation is not necessary for execution of the image forming operation, and is therefore included in the predetermined non-image-forming operation. In contrast, the post-rotation operation following the image forming operation is necessary for execution of the image forming operation, and is therefore treated as the non-image-forming operation other than the predetermined non-image-forming operation.

### Pre-Start Operation

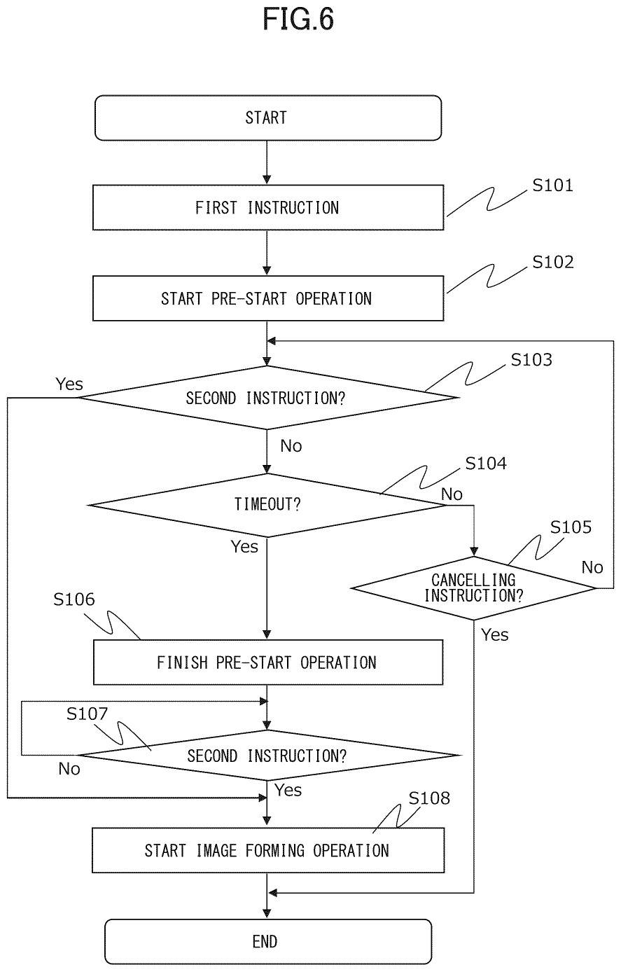

The pre-start operation in Example 1 will be described. FIG. 6 is a flowchart of the pre-start operation.

As illustrated in FIG. 6, when the image formation command (print signal) is received, the image controller portion 205 issues a first instruction (image formation preparation instruction). The image formation command is transmitted to the image forming apparatus 100 from a host computer 700 together with image formation conditions and image data by an operation by an operator such as a user. The image formation conditions are setting conditions applied when executing the image forming operation, such as designation of the size and type of the recording material P to be used for image formation, designation of simplex/duplex printing, and whether image quality is prioritized or toner consumption amount is prioritized. The controller 200 starts the pre-start operation (S102) on the basis of reception (S101) of the first instruction from the image controller portion 205.

In the pre-start operation, driving of each rotary member in the process unit 9 and the fixing device 14 is started by the motor M1, and heating of the fixing device 14 is started. That is, in a state in which the developing roller 4 is rotated, power supply to the heating portion of the fixing device 14 is started, and the fixing roller and the pressurizing roller are pre-heated. In addition, in the developing device 8, the toner is agitated and uniformized by the rotation of the developing roller 4, the supply roller 5, and the agitation member 7.

At the start of the pre-start operation, analysis of the data received from the host computer 700 is not finished. Therefore, at the start of the pre-start operation, the controller 200 cannot determine in what kind of image formation conditions the image forming operation is to be executed next. Therefore, the conditions (for example, target temperature of the fixing device 14) of the pre-start operation are set in consideration of typical image formation conditions. The typical image formation conditions are, for example, conditions for a plain paper sheet of the A4 size.

The controller 200 stands by for transmission of the second instruction (image formation start instruction) from the image controller portion 205 after the pre-start operation is started. When the second instruction is transmitted from the image controller portion 205 (Yes in S103), the controller 200 starts the image forming operation (first image forming operation in the image forming job) (S108).

In contrast, in the case where it is determined that an applicable time of the pre-start operation is exceeded (timeout) during the stand-by after the start of the pre-start operation (Yes in S104), the controller 200 finishes the pre-start operation (S106). In this case, the controller 200 stops the heating of the fixing device 14 (finishes the pre-heating), and executes an operation (post-rotation) of continuing the rotation of the motor M1 for a predetermined time. The post-rotation operation is executed to avoid a situation in which, for example, in the case where the rotation of the fixing roller and the pressurizing roller is stopped simultaneously with the stop of the heating of the fixing device 14, heat builds up in the fixing nip and changes the shape, nature, and the like of the surface of the roller. Then, when the second instruction is transmitted from the image controller portion 205 (Yes in S107), the controller 200 starts the image forming operation (S108).

To be noted, in the case of starting the image forming operation after the timeout of the pre-start operation, the controller 200 executes the pre-rotation operation that is a preliminary operation of the image forming operation. In the pre-rotation operation, the driving of each rotary member in the process unit 9 and the fixing device 14 is started by the motor M1, and the heating of the fixing device 14 is started. The difference from the pre-start operation is that the pre-rotation operation is started on the basis of the second instruction and that transition to the image forming operation does not need an additional instruction from the image controller portion 205 (image forming operation is automatically started sequentially from the pre-rotation operation).

In addition, in the case where a cancelling instruction is received from the image controller portion 205 during the stand-by after the start of the pre-start operation (Yes in S105), the controller 200 executes the post-rotation operation, and finishes the processing without executing the image forming operation.

As described above, the pre-start operation (first preliminary operation) includes an operation similar to the operation of the process unit 9 and the fixing device 14 in the pre-rotation operation (second preliminary operation). In other words, the pre-start operation is an operation to start a step similar to the pre-rotation operation that is preparation for the image forming apparatus at a timing earlier than the second instruction (image formation start instruction). In addition, in the case of the pre-start operation, the driving of each rotary member in the process unit 9 and the fixing device 14 is continued and the temperature of the fixing device 14 is maintained, even after the preparation for the image forming operation is executed in a similar step to the pre-rotation operation. Therefore, after the start of the pre-start operation, in the case where timeout or the cancelling instruction has not occurred after the start of the pre-start operation and the second instruction is received, the controller 200 can start the image forming operation without executing the pre-rotation operation.

In contrast, in the case where the second instruction (image formation start instruction) is received when the pre-start operation (first preliminary operation) is not executed, the controller 200 starts the image forming operation after executing the pre-rotation operation (second preliminary operation). The time when the pre-start operation is not executed includes a case where the pre-start operation is stopped by the timeout, and a case where the execution of the pre-start operation is prohibited as a result of applying a suppression mode that will be described later.

As described above, the controller 200 starts the pre-start operation when the first instruction is received from the image controller portion 205. The first instruction is a signal notifying the controller 200 that an image formation command from the user has been input. In other words, the first instruction is a signal instructing the controller 200 to prepare for the image forming operation when the image formation command is received from the outside with the image data. The first instruction of the present example can be also referred to as a signal instructing the controller 200 to start the pre-start operation to prepare for the image forming operation.

In addition, the controller 200 starts the image forming operation when the second instruction is received from the image controller portion 205. The second instruction is a signal notifying the controller 200 that transmission of the video signal for driving the exposing device 10 can be started after the image controller portion 205 interprets the content of the image formation command. The second instruction can be also referred to as a signal instructing the controller 200 to start the image forming operation. When processing of the image data received from the host computer 700 together with the image formation command is completed (or when completion of the processing is expected), the image controller portion 205 issues the second instruction.

In addition, in the case where a stop instruction is received from the image controller portion 205 after the first instruction is received and before the second instruction is received, the controller 200 stops the pre-start operation. The stop instruction is a signal to stop (temporarily stop or terminate) the operation started in accordance with the first instruction. The image controller portion 205 issues the stop instruction in the case where an instruction to cancel the image formation command is received from the host computer 700 as a result of the operation by the operator.

In addition, the controller 200 stops (temporarily stops or terminates) the pre-start operation also in the case where a predetermined time has elapsed (timed out) without receiving the second instruction after the first instruction is received. This is a case where the time for the image controller portion 205 to process the image data exceeds a predetermined time that is set in advance.

Here, there is a case where the second instruction is transmitted to the controller 200 after the pre-start operation started by the first instruction is stopped or finished. Such a second instruction is for, for example, image data different from the image data for which the cancellation or timeout has occurred among a plurality of pieces of image data transmitted together with the image formation command.

### Toner Remainder Amount Detection Operation

The toner remainder amount detection operation in Example 1 is executed assuming a case where the usage amount of the toner 3 (FIG. 1) is biased in the longitudinal direction of the toner accommodation chamber 8a. This toner remainder amount detection operation includes a step of flattening the biased distribution of the toner 3 in the developing container 80 (flattening step), and a step of detecting the toner amount T in the developing container 80 by the toner amount sensor 20 (detection step).

The flattening step is executed sequentially from the image forming operation. In the flattening step, substantially the same charging bias and developing bias as in the image formation are applied to the charging roller 2 and the developing roller 4, and each rotary member is rotationally driven by the motor M1. In the present example, the motor driving time in the flattening step is set to, for example, 30 sec. In the toner remainder amount detection operation, radiation of light from the exposing device 10 is not executed because no image is to be formed. When the motor M1 rotates without executing image formation, the toner 3 in the toner accommodation chamber 8a is flattened by the agitation member 7, and thus the biased distribution of the toner 3 in the longitudinal direction is relieved.

A detection step is executed sequentially from the flattening step. The detection step is the same as the detection method for the toner amount T described above. That is, the toner amount calculation portion 300 calculates the toner amount on the basis of the signal of the toner amount sensor 20 in a period in which the agitation member 7 is rotationally driven.

The toner amount detection operation is executed in the case where there is a possibility that a certain amount of toner has been consumed. In the present example, in the case where the number of times the image forming operation has been executed (print count) in the job exceeds a preset threshold value, the toner remainder amount detection operation is executed after the final image forming operation of the job is finished. The threshold value of the number of executions of the image forming operation is set to, for example, 10 sheets. That is, in the case where the print count after the execution of the previous toner remainder amount detection operation and before the current job is finished is 10 or more, the toner remainder amount detection operation is executed immediately after the current job is finished.

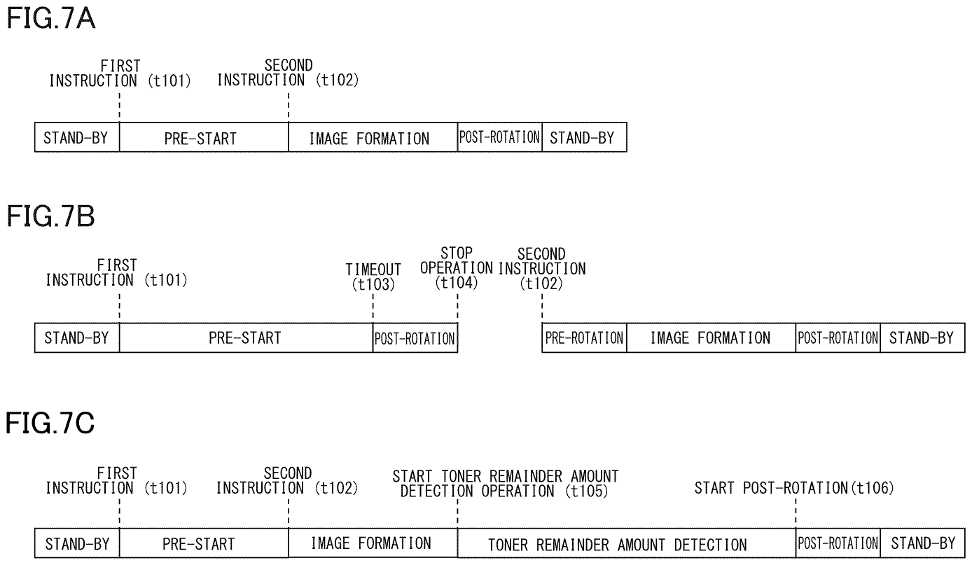

FIGS. 7A to 7C are each a timing chart illustrating an example of execution of the predetermined non-image-forming operation in Example 1.

FIG. 7A illustrates a case where, after the controller 200 receives the first instruction in step S103 of FIG. 6, timeout or cancelling instruction does not occur and the second instruction is received. In the case of FIG. 7A, the controller 200 transitions from the stand-by state (waiting state in which an image formation command can be received) to execution of the pre-start operation (S102) on the basis of the first instruction (S101). Then, the controller 200 transitions to execution of the image forming operation (S108) on the basis of the second instruction (Yes in S103). When the image forming operation is finished, the controller 200 executes the post-rotation operation following the image forming operation, and then returns to the stand-by state. In the case where the time when the first instruction is received is t101 and the time when the second instruction is received is t102, the length of the period in which the pre-start operation is executed is (t102−t101).

FIG. 7B illustrates a case where it is determined in step S104 of FIG. 6 that timeout has occurred. In the case of FIG. 7B, the controller 200 transitions to the execution of the pre-start operation (S102) from the stand-by state on the basis of the first instruction (S101), but stops the pre-start operation (S106) due to the occurrence of timeout (Yes in S104). At this time, the controller 200 executes the post-rotation operation following the stop of the pre-start operation, and then takes a state of waiting for the second instruction. Then, the controller 200 starts execution of the image forming operation (S108) when the second instruction is received (Yes in S107). At this time, the driving of each rotary member of the process unit 9 and the fixing device 14 and the pre-heating of the fixing device 14 are stopped as a result of the stop of the pre-start operation, and therefore the controller 200 starts the image forming operation after executing the pre-rotation operation again on the basis of the second instruction. When the image forming operation is finished, the controller 200 executes the post-rotation operation following the image forming operation, and then returns to the stand-by state.

The time when the first instruction is received in the case of FIG. 7B will be referred to as t101, the time when it is determined that time is out will be referred to as t103, and the time when the controller 200 stops the pre-start operation will be referred to as t104. In this case, the length of the period in which the pre-start operation is executed is (t103−t101). In addition, the length of the period in which the post-rotation operation for stopping the pre-start operation is executed is (t104−t103). That is, the length of the period in which the predetermined non-image-forming operation is executed in the case where it is determined that time is out after the start of the pre-start operation is (t104−t101) that is the sum of the pre-start operation and the post-rotation operation.

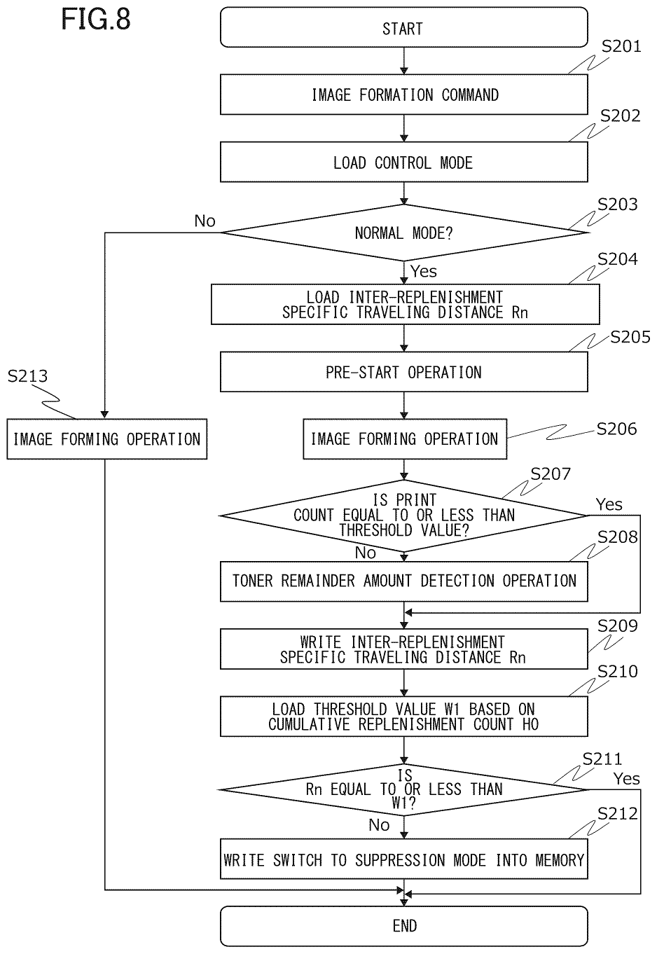

FIG. 7C illustrates a case where after the controller 200 receives the first instruction in step S103, timeout or cancelling instruction does not occur and the second instruction is received and where the toner remainder amount detection operation is executed after the image forming job is finished. Similarly to the case of FIG. 7A, after the controller 200 transitions from the stand-by state to execution of the pre-start operation (S102) on the basis of the first instruction (S101), the controller 200 transitions to execution of the image forming operation (S108) on the basis of the second instruction (Yes in S103). However, in the case of FIG. 7C, the controller 200 executes the toner remainder amount detection operation (S208 in FIG. 8 described later) after the image forming operation is finished, and then returns to the stand-by state after executing the post-rotation operation.

The time when the toner remainder amount detection operation is started will be referred to as t105, and the time when the post-rotation operation following the toner remainder amount detection operation is started will be referred to as t106. In this case, the length of the period in which the toner remainder amount detection operation is executed is (t106−t105). That is, in the case where the image forming operation is started after the start of the pre-start operation on the basis of the second instruction and the toner remainder amount detection operation is executed when the job is finished, the length of the period in which the predetermined non-image-forming operation is executed is (t102−t101)+(t106−t105).

To be noted, in the present example, the rotation time of the motor M1 in each step of the toner remainder amount detection operation is fixed to a preset time, but the configuration is not limited to this. The flattening step and the detection step may be executed in parallel, and the toner remainder amount detection operation may be finished in the case where it is determined that the detection of the toner amount in the detection step has been executed appropriately (the detection result of the toner amount has settled down). In addition, the rotation time of the motor M1 in the flattening step may be shortened in accordance with the usage status of the image forming apparatus to suppress the traveling distance of the developing roller 4. Even if the rotation time of the motor M1 in the flattening step is shortened, the precision of the toner remainder amount detection is improved as compared with at least a case where the flattening step is omitted.

### Management of Developing Roller Traveling Distance

Next, the management method for the traveling distance of the developing roller 4 in Example 1 will be described.

As described above, the controller 200 includes the traveling distance detection portion 400 that detects the traveling distance of the developing roller 4. The traveling distance detection portion 400 of the present example includes a traveling distance measuring portion 401, and a traveling distance calculation portion 402. The traveling distance measuring portion 401 measures the traveling distance of the developing roller 4, and detects the traveling distance reaching a predetermined amount Ru. The traveling distance calculation portion 402 adds the predetermined amount Ru to the current values of the cumulative traveling distance R0 and the inter-replenishment traveling distance Ry stored in the memory 15 each time the traveling distance of the developing roller 4 reaching the predetermined amount Ru is detected by the traveling distance measuring portion 401. Then, the traveling distance detection portion 400 updates R0 and Ry in the memory 15 by the value to which the predetermined amount Ru has been added.

In addition to what has been described above, the inter-replenishment specific traveling distance Rn is updated in the case where the operation status determination portion 800 determines that the predetermined non-image forming operation is being executed. That is, the traveling distance calculation portion 402 adds the predetermined amount Ru to the current value of an inter-replenishment specific traveling distance Rn stored in the memory 15 each time the traveling distance measuring portion 401 detects the increase in the traveling distance of the developing roller 4 by the predetermined amount Ru while the predetermined non-image-forming operation is executed. Then, the traveling distance detection portion 400 updates Rn in the memory 15 by a value obtained by adding the predetermined amount Ru.

To be noted, as described above, when the replenishment operation is executed, Ry and Rn in the memory 15 are reset, and Ry=Rn=0 holds.

### Change of Control Mode

As described above, the predetermined non-image-forming operations each contribute to improvement in the performance of the image forming apparatus 100 (improvement in the usability). For example, the pre-start operation contributes to shortening of FPOT, the toner remainder amount detection operation can improve the detection accuracy of the toner remainder amount, and can optimize the timing of the replenishment request notification. On the other hand, since the predetermined non-image-forming operation is not necessary for execution of the image forming operation, the image forming function (printing function) that is a main function of the image forming apparatus 100 is not lost even in the case where the predetermined non-image-forming operation is omitted.

Therefore, in a situation in which a trouble such as an image defect does not occur, it may be preferable to execute the predetermined non-image-forming operation. However, in the case where there is a possibility that a trouble such as an image defect occurs, the predetermined non-image-forming operation may be omitted.

Here, when the image forming operation is repeated, deterioration of the toner in the developing container 80 progresses. Specifically, in the toner in the developing container 80, external additives added to the toner are detached from or embedded in (buried in) resin particles serving as bodies of the toner particles as a result of, for example, the toner particles rubbing each other or being rubbed by the supply roller 5 and the developing blade 6. The external additive is an additive that is added to improve the performance of the toner, such as to adjust the charging performance, the agglomerating property, and the like of the toner, and examples thereof include silica particles and polytetrafluoroethylene (PTFE) particles. When the external additives are detached or embedded (buried), the performance of the toner can deteriorate as compared with fresh toner by, for example, deterioration of the charging performance of the toner.

An example of a trouble that occurs in the case where the performance of the toner deteriorates is image fogging. Image fogging is an image defect in which a thin layer of toner attaches to a region (blank portion) of the recording material where the image is not supposed to be formed. The image fogging occurs when the charging performance of the toner deteriorates and the ratio of the toner having an insufficient amount of charges in the toner on the developing roller 4 increases. The toner having an insufficient amount of charges attaches to the non-image portion regardless of the potential difference (also referred to as a de-fogging contrast Vback) between the developing voltage and the surface potential of the photosensitive drum 1. The image fogging occurs when such toner is transferred to the recording material P in the transfer portion TS.

In addition, the image fogging can occur also due to consumption (wear and degradation of the surface) of the developing roller 4. The consumption of the developing roller 4 progresses in accordance with the increase in the cumulative traveling distance R0 of the developing roller 4.

### Normal Mode and Suppression Mode

The controller 200 of the present example is configured to be capable of switching the control mode between a normal mode and a suppression mode. The controller 200 changes the control mode on the basis of the inter-replenishment specific traveling distance Rn.

The normal mode is a mode (first mode) in which the predetermined non-image-forming operation is executed on the basis of a preset start condition in a non-image-forming period in which the image forming operation is not executed. In the normal mode, for example, the controller 200 of the present example executes the pre-start operation each time the first instruction described above is received, and executes the toner remainder amount detection operation each time the cumulative print count N0 increases by a predetermined number. In other words, in the normal mode, the controller 200 executes the next toner remainder amount detection operation in the case where the cumulative number of executions of the image forming operation since the last execution of the toner remainder amount detection operation is equal to or more than a first predetermined number.

In contrast, the suppression mode is a mode (second mode) in which the execution frequency of the predetermined non-image-forming operation in the non-image-forming period is lower than in the normal mode. “Execution frequency is low” includes a case where the number of executions is 0. That is, the suppression mode (second mode) may be a mode in which the predetermined non-image-forming operation is not executed at all, or a mode in which the predetermined non-image-forming operation is executed at a lower execution frequency than in the normal mode.

In addition, in the case where the “predetermined non-image-forming operation” includes a plurality of kinds of operations, it suffices as long as the execution frequency is lower than in the normal mode for at least one kind of operation in the suppression mode. That is, in the case of the present example, it suffices as long as the execution frequency in the suppression mode is lower than in the normal mode for at least one of the pre-start operation and the toner remainder amount detection operation. In other words, the controller 200 executes the next toner remainder amount detection operation in the case where the cumulative number of executions of the image forming operation since the execution of the last toner remainder amount detection operation is equal to or more than a second predetermined number larger than the first predetermined number. Alternatively, the controller 200 may be configured not to execute the toner remainder amount detection operation in the suppression mode even when the cumulative number of executions of the image forming operation increases after the last execution of the toner remainder amount detection operation.

In the description below, description will be given assuming that the suppression mode of the present example is a mode in which the pre-start operation and the toner remainder amount detection operation serving as predetermined non-image-forming operations are not executed at all. In the case of not executing the toner remainder amount detection operation of the present example, for example, the controller 200 detects the toner amount in the developing container 80 by using a signal of the toner amount sensor 20 during execution of the image forming operation.

Switch from Normal Mode to Suppression Mode

The control mode of the controller 200 of the present example is set to the normal mode in the initial settings. The controller 200 is configured to switch from the normal mode to the suppression mode on the basis of the inter-replenishment specific traveling distance Rn detected by the traveling distance detection portion 400, and the cumulative replenishment count H0 detected by the replenishment request processing portion 600.

Specifically, the controller 200 is configured to be in the normal mode when the inter-replenishment specific traveling distance Rn is equal to or less than a predetermined threshold value W1 (0≤Rn≤W1), and switch from the normal mode to the suppression mode in the case where Rn exceeds W1 (Rn>W1). That is, the controller 200 executes the mode change as an example of first processing in the case where the cumulative traveling distance of the developing roller 4 (developer bearing member) by the predetermined non-image-forming operation) since the replenishment operation of replenishing the developing container 80 (accommodation portion) with developer exceeds the predetermined threshold value (W1).

Details of mode control based on the inter-replenishment specific traveling distance Rn and the cumulative replenishment count H0 will be described below.

In Example 1, the threshold value W1 is changed in accordance with the cumulative replenishment count H0. Specifically, as shown in Table 1, a plurality of values are set as the threshold value W1 of the inter-replenishment specific traveling distance Rn in accordance with the cumulative replenishment count H0. For example, the information shown in Table 1 is stored in the ROM 203 in advance. As shown in Table 1, the threshold value W1 is configured to decrease as the cumulative replenishment count H0 increases. In other words, the threshold value W1 is smaller when the cumulative number of times of the replenishment operation is a second number (for example, two) larger than a first number (for example, zero) than when the cumulative number is the first number.

TABLE 1

| | Cumulative replenishment count H0 | | | |
|---|---|---|---|---|
| | 0 | 1 | 2 | 3 or more |
| Threshold value W1 of | 5.3 | 4.0 | 2.7 | 1.3 |
| inter-replenishment | | | | |
| specific traveling distance | | | | |
| Rn (km) | | | | |

In Example 1, the control mode of the controller 200 is changed from the normal mode to the suppression mode when the inter-replenishment specific traveling distance Rn exceeds the predetermined threshold value W1. The switch from the normal mode to the suppression mode is an example of first processing to lower the execution frequency of the predetermined non-image-forming operation as compared with a case where the cumulative traveling distance (Rn) of the developing roller 4 by the predetermined non-image-forming operation since the last replenishment operation exceeds the threshold value described above.

In the case where the inter-replenishment specific traveling distance Rn is large, there is a possibility that the deterioration of the toner such as detachment or embedding (burying) of the external additives has occurred as a result of repetitive use of the toner in the developing container 80 for image formation. Therefore, progress of the deterioration of the toner can be suppressed while maintaining the image forming function by switching the controller 200 to the suppression mode in the case where the Rn exceeds the threshold value W1 and thus suppressing the execution of the predetermined non-image-forming operation unnecessary for a normal image forming operation. In addition, by switching the controller 200 to the suppression mode, the increase speed of the cumulative traveling distance R0 of the developing roller 4 is also lowered, and thus the consumption of the developing roller 4 is also slowed down.

Therefore, by switching the controller 200 to the suppression mode on the basis of the inter-replenishment specific traveling distance Rn, the progress of the deterioration of the toner can be suppressed, and thus image fogging can be made less likely to occur.

In addition, the threshold value W1 is determined on the basis of the cumulative replenishment count H0. That is, the threshold value W1 is changed in accordance with the cumulative replenishment count H0. This is because in the developing container 80 after the replenishment operation, deteriorated old toner and replenished fresh toner are present in a mixed state, and the nature of the toner in the developing container 80 is deteriorated in average as compared with fresh toner. That is, whereas the influence of the deterioration of the toner and the consumption of the developing roller 4 is relieved by the replenishment operation, the history of the deterioration of the toner and the consumption of the developing roller 4 before the replenishment operation still remains after the replenishment operation. In addition, the degree by which the history remains increases as the replenishment operation is repeated.

Therefore, by determining the threshold value W1 on the basis of the cumulative replenishment count H0, the mode of the controller 200 can be changed at a more appropriate timing in consideration of the degree of the deterioration of the toner and the consumption of the developing roller 4 from before the replenishment operation. As a result of this, improvement in the usability by the predetermined non-image-forming operation and suppression of the image fogging by the switch to the suppression mode can be achieved simultaneously.

A control method related to the switch from the normal mode to the suppression mode in Example 1 will be described with reference to FIG. 8. FIG. 8 is a flowchart illustrating an example of control executed by the controller 200 in Example 1.

First, when the image formation command (print signal) is transmitted to the image forming apparatus 100 (S201), the controller 200 communicates with the memory 15 and reads the current control mode of the controller 200 (S202).

Next, in step S203, the controller 200 determines whether or not the current control mode is the normal mode. In the case where it is determined that the current control mode is not the normal mode (where the control mode has been already switched to the suppression mode), the image forming operation is executed (S213), and the processing of the present flow is finished. In the case of the suppression mode, the pre-start operation and the toner remainder amount detection operation are not executed as described above. The controller 200 starts the pre-rotation operation on the basis of the image formation start instruction (second instruction) from the image controller portion 205, executes the image forming operation sequentially from the pre-rotation operation, executes the post-rotation operation sequentially from the image forming operation, and finishes the job.

In contrast, in the case where it is determined in step S203 that the current control mode is the normal mode, the controller 200 proceeds to the processing of step S204. In step S204, the controller 200 communicates with the memory 15, reads the inter-replenishment specific traveling distance Rn, and executes the pre-start operation (S205). Next, the controller 200 starts the image forming operation on the basis of the image formation start instruction (second instruction) from the image controller portion 205 (S206). The procedure of execution of the pre-start operation at this time corresponds to steps S101 to S108 of FIG. 6.

Next, the controller 200 determines whether or not the increase in the print count since the toner remainder amount detection operation of the previous time is equal to or less than a preset threshold value (S207). In the case where it is determined in step S207 that the print count exceeds the threshold value, the controller 200 executes the toner remainder amount detection operation after finishing the final image forming operation in the job (S208, see FIG. 7C). In contrast, in the case where it is determined in step S207 that the print count is equal to or less than the threshold value, the controller 200 proceeds to the processing of step S209.

In step S209, the controller 200 writes the inter-replenishment specific traveling distance Rn into the memory 15 on the basis of the calculation result of the traveling distance calculation portion 402. In step S210, the controller 200 loads the value of the cumulative replenishment count H0 by communicating with the memory 15, and loads the threshold value W1 corresponding to the current value of the cumulative replenishment count H0 by referring to the information of Table 1.

Next, in step S211, the controller 200 determines whether or not the current value of the inter-replenishment specific traveling distance Rn is equal to or less than the threshold value W1 loaded in step S210. In the case where it is determined in step S211 that Rn is equal to or less than W1, the controller 200 skips the processing of changing the control mode in step S212, and finishes the processing of the present flow. In contrast, in the case where it is determined in step S211 that Rn is larger than W1, the controller 200 writes the switch of the control mode from the normal mode to the suppression mode into the memory 15 (S212), and finishes the processing of the present flow. The processing of switching the mode executed by the controller 200 from the normal mode (first mode) to the suppression mode (second mode) in step S212 is an example of first processing. To be noted, in the case where the processing of step S212 is executed in the current image forming job, the control mode referred to in step S203 is the suppression mode when executing the next image forming job, and therefore the pre-start operation (S205) and the toner remainder amount detection operation (S208) are not executed.

Switch from Suppression Mode to Normal Mode

Next, the switch from the suppression mode to the normal mode according to the replenishment operation will be described. In a state in which the control mode of the controller 200 is the suppression mode, the controller 200 is switched from the suppression mode to the normal mode in the case where the operator executes the replenishment operation on the basis of the replenishment operation execution request from the replenishment request processing portion 600. This is because since the image fogging is suppressed as a result of replenishment with fresh toner by the replenishment operation, it may be preferable to execute the predetermined non-image-forming operation for improving the usability.

The switch from the suppression mode to the normal mode is an example of second processing of increasing the execution frequency of the predetermined non-image-forming operation, as compared with a period from the execution of the first processing to the replenishment operation for the next time, in the case where the replenishment operation for the next time is executed after the first processing is executed.

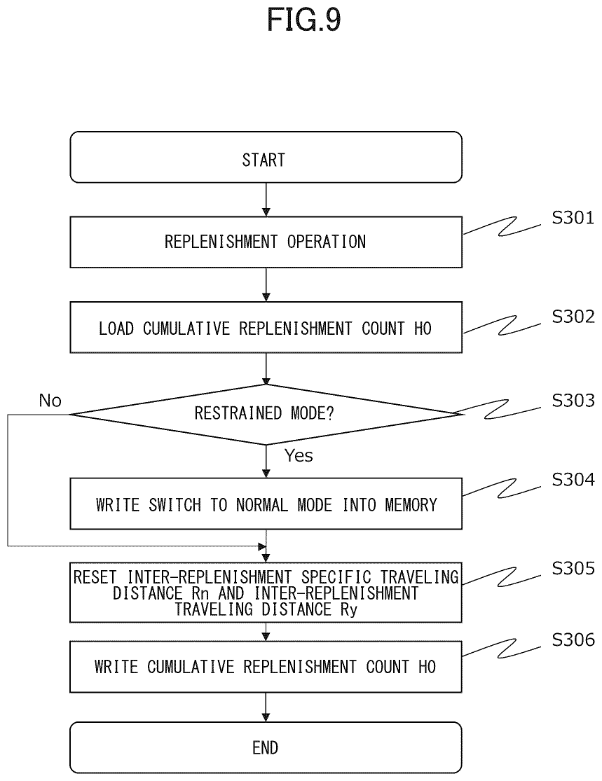

A control method related to the switch from the suppression mode to the normal mode in Example 1 will be described with reference to FIG. 9. FIG. 9 is a flowchart illustrating an example of control executed by the controller 200 in Example 1.

As described above, the replenishment request processing portion 600 executes replenishment request notification prompting the operator to execute the replenishment operation on the basis of the toner amount T calculated by the toner amount calculation portion 300. When the replenishment operation is executed by the operator on the basis of the request from the replenishment request processing portion 600 (S301), the controller 200 communicates with the memory 15, and loads the cumulative replenishment count H0 (S302).

In step S303, the controller 200 determines whether or not the current control mode is the normal mode. In the case where it is determined that the current control mode is the suppression mode, the controller 200 writes the switch from the suppression mode to the normal mode into the memory 15 (S304). The processing of step S304 in which the mode executed by the controller 200 is changed from the suppression mode (second mode) to the normal mode (first mode) is an example of second processing. In contrast, in the case where it is determined that the current control mode is the normal mode, the controller 200 skips the step S304 and proceeds to step S305.

In step S305, the controller 200 resets the inter-replenishment specific traveling distance Rn and the inter-replenishment traveling distance Ry. That is, the controller 200 communicates with the memory 15, and writes Rn=0 and Ry=0. Next, in step S306, the controller 200 communicates with the memory 15, writes a value obtained by adding 1 to the current value as the cumulative replenishment count H0, and finishes the processing of the present flow.

To be noted, what has been described above is an example of a control method based on the inter-replenishment specific traveling distance Rn, and the order of the steps or details of the processing in each step may be changed. For example, the processing of loading the inter-replenishment specific traveling distance Rn from the memory 15 (S204) may be executed at a timing different from the execution timing in the present flow (between S205 and Yes in S203).

In addition, in the present example, since the inter-replenishment specific traveling distance Rn is defined as an amount that increases in accordance with the rotation of the developing roller 4 by the execution of the predetermined non-image-forming operation, switch from the normal mode to the suppression mode (S212) is executed in the case where the value of Rn exceeds the threshold value W1 (No in S211). The configuration is not limited to this, and the inter-replenishment specific traveling distance Rn may be defined as an amount that decreases in accordance with the rotation of the developing roller 4 by the predetermined non-image-forming operation. That is, the configuration is not limited to a configuration in which Rn is counted up when the predetermined non-image-forming operation is executed, and Rn may be counted down when the predetermined non-image-forming operation is executed. In this case, the flow of FIG. 8 may be corrected such that the switch from the normal mode to the suppression mode (S212) is executed in the case where the value of Rn has become below the threshold value W1.

### Evaluation Experiment

Next, an evaluation experiment conducted to verify the control of Example 1 will be described. In the present experiment, an image forming job of printing two test images per job was repeatedly executed by each of the image forming apparatus of Example 1 and an image forming apparatus of Comparative Example 1 in an environment of 23° C./50% RH. As the image data for the test image, a horizontal line pattern of an image coverage of 4% was used.

The image forming apparatus of Comparative Example 1 is configured similarly to the image forming apparatus of Example 1 except that the control mode of the controller 200 is fixed to the normal mode. In Example 1, after the replenishment operation, the control mode of the controller 200 is changed from the normal mode to the suppression mode in the case where the inter-replenishment specific traveling distance Rn reaches the threshold value W1 based on Table 1. In contrast, in Comparative Example 1, the normal mode is continued regardless of the value of the inter-replenishment specific traveling distance Rn.

In the normal mode of Example 1, the toner remainder amount detection operation is set to be executed each time printing was executed by ten print counts (for every 5 jobs). In addition, in the normal mode, the traveling distance of the developing roller 4 for every ten print counts (i.e., for every five jobs) is 1.5 times as long as the traveling distance in the suppression mode as a result of the pre-start operation and the toner remainder amount detection operation. When the developing device 8 is brand-new, 150 g of toner is stored in the developing container 80. The replenishment request processing portion 600 is configured to execute the replenishment request notification in the case where the toner amount T in the developing container 80 being 50 g or less is detected by the toner amount sensor 20 such that the replenishment operation is executed immediately. In the case where the replenishment operation in the replenishment operation is denoted by Hk, Hk in the present example is set to 100 (g).

In the present experiment, the accumulated printing number at a time point when image fogging occurred was evaluated for Example 1 and Comparative Example 1.

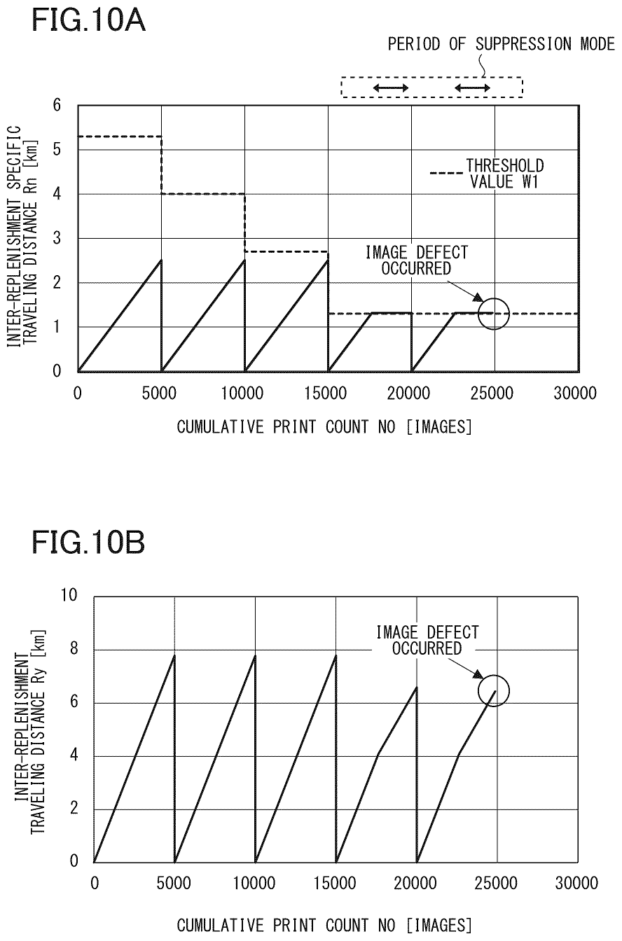

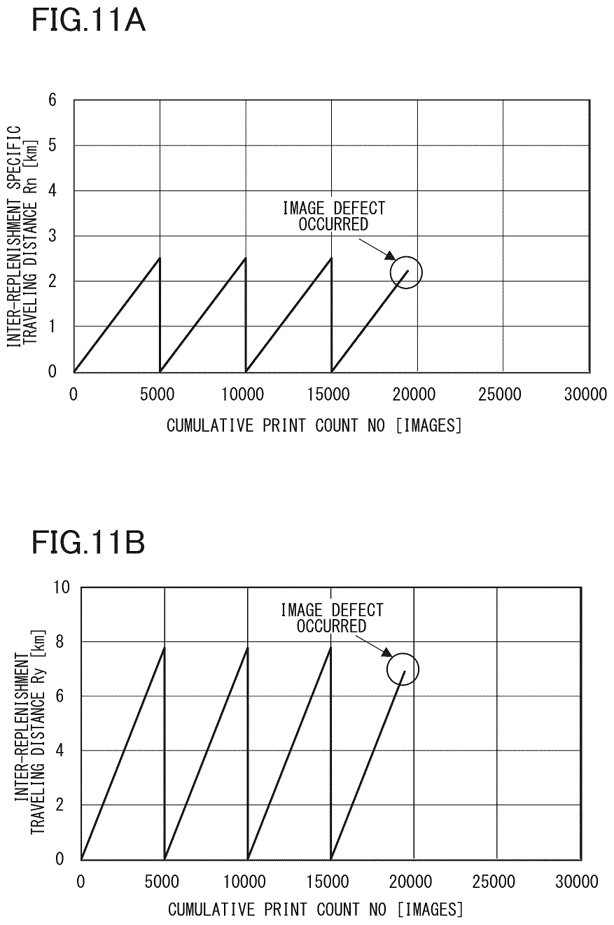

The experimental results will be described with reference to FIGS. 10A to 11B. FIG. 10A illustrates the transition of the inter-replenishment specific traveling distance Rn with respect to the cumulative print count N0 in Example 1. FIG. 10B illustrates the transition of the inter-replenishment traveling distance Ry with respect to the cumulative print count N0 in Example 1. FIG. 11A illustrates the transition of the inter-replenishment specific traveling distance Rn with respect to the cumulative print count N0 in Comparative Example 1. FIG. 11B illustrates the transition of the inter-replenishment traveling distance Ry with respect to the cumulative print count N0 in Comparative Example 1.

As illustrated in FIG. 11A, in Comparative Example 1, the normal mode is continued regardless of the inter-replenishment specific traveling distance Rn, and the predetermined non-image-forming operation (pre-start operation and toner remainder amount detection operation) is executed at a constant frequency. Therefore, as illustrated in FIGS. 11A and 11B, the inter-replenishment specific traveling distance Rn and the inter-replenishment traveling distance Ry increases at a constant speed with respect to the cumulative print count N0 while being reset each time the replenishment operation is executed.

In contrast, as illustrated in FIG. 10A, in Example 1, the mode change from the normal mode to the suppression mode is executed when the inter-replenishment specific traveling distance Rn exceeds the threshold value W1. In addition, in Example 1, the mode change from the suppression mode to the normal mode is executed when the replenishment operation is executed.

Specifically, in a section in which the cumulative print count N0 is 15,000 or less, the inter-replenishment specific traveling distance Rn does not exceed threshold value W1, and therefore the behavior of Example 1 is the same as that of Comparative Example 1. However, in a section in which the cumulative print count N0 is from 15,000 to 20,000, the inter-replenishment specific traveling distance Rn exceeds the threshold value W1 for the first time, and the mode change from the normal mode to the suppression mode is executed. During the period of the suppression mode, the predetermined non-image-forming operation (pre-start operation and toner remainder amount detection operation) is not executed, and therefore, the increase in the inter-replenishment specific traveling distance Rn stops. In addition, since the increase in the inter-replenishment specific traveling distance Rn stops, the increase speed of the inter-replenishment traveling distance Ry becomes lower as illustrated in FIG. 10B.

Then, when the replenishment operation is executed, the inter-replenishment specific traveling distance Rn is reset, and the control mode is switched from the suppression mode to the normal mode. As a result of this, Rn starts increasing again with respect to the cumulative print count N0, and the increase rate of Ry also increases. When the inter-replenishment specific traveling distance Rn exceeds the threshold value W1 again, the mode is switched from the normal mode to the suppression mode again.

TABLE 2

| | | Comparative |
|---|---|---|
| | Example 1 | Example 1 |
| Cumulative print count N0 at the | 25,000 | 19,500 |
| time of occurrence of image fogging | | |

Table 2 shows, as the evaluation results of the present experiment, the cumulative print count N0 when image fogging occurred in Example 1 and Comparative Example 1. In Example 1, image fogging occurred when the cumulative print count N0 was 25,000. In contrast, in Comparative Example 1, image fogging occurred when the cumulative print count N0 was 19,500.

The results of Table 2 show that occurrence of image fogging can be suppressed by the control of Example 1 as compared with Comparative Example 1. This is because by executing the switch from the normal mode to the suppression mode on the basis of the value of the inter-replenishment specific traveling distance Rn, execution of the predetermined non-image-forming operation is suppressed, and the deterioration of the toner and the consumption of the developing roller 4 are suppressed.

As described above, the image forming apparatus 100 according to Example 1 is configured to be capable of executing the normal mode and the suppression mode. In addition, according to Example 1, the mode change from the normal mode to the suppression mode is executed on the basis of the inter-replenishment specific traveling distance Rn, and execution of the predetermined non-image-forming operation is suppressed. As a result of this, progress of deterioration of the toner can be suppressed, and occurrence of image fogging can be suppressed. In addition, the number of images that can be printed without the occurrence of image fogging can be increased.

That is, according to the present example, an image forming apparatus capable of suppressing deterioration of toner can be provided.

Further, according to Example 1, the threshold value W1 to determine the switch timing to the suppression mode is determined on the basis of the cumulative replenishment count H0. If the threshold value W1 is fixed to a small value regardless of the cumulative replenishment count H0, the mode switch to the suppression mode is executed when the toner has not deteriorated much, and thus the improvement in the usability cannot be obtained by the predetermined non-image-forming operation. In addition, in the case where the threshold value W1 is fixed to a large value regardless of the cumulative replenishment count H0, the mode change to the suppression mode is not executed even though the deterioration of toner has progressed, and thus the effect of suppressing the image fogging is less likely to be obtained. In contrast, according to the present example, the improvement in the usability by the predetermined non-image-forming operation and suppression of image fogging by the switch to the suppression mode can be achieved simultaneously.

### Modification Example

Although a configuration in which the pre-start operation and the toner remainder amount detection operation serving as the predetermined non-image-forming operations are not executed at all in the suppression mode is employed in Example 1, a configuration in which a cleaning operation is executed at a lower frequency in the suppression mode than in the normal mode may be employed. Also in this case, deterioration of the toner can be suppressed as compared with Comparative Example 1 in which the control mode is fixed to the normal mode.

In addition, although the pre-start operation and the remainder amount detection operation have been described as two examples of the predetermined non-image-forming operation in Example 1, the predetermined non-image-forming operation may include an operation other than these. For example, cleaning operation of the developing roller 4, the photosensitive drum 1, the charging roller 2, or the transfer roller 13 may be executed regularly in accordance with the cumulative print count N0, the cumulative traveling distance R0 of the developing roller 4, and the like. In the cleaning operation, each rotary member such as the developing roller 4 is rotationally driven by the motor M1. Such cleaning operation is an example of the predetermined non-image-forming operation.

The electric characteristics (resistance value and the like) of the members to which a voltage is applied, such as the developing roller 4, the charging roller 2, and the transfer roller 13 can change as a result of repeatedly executing image formation. Therefore, the image quality may be maintained by detecting the change in the electric characteristics in accordance with the cumulative print count N0 and the cumulative power supply time and correcting the value of the applied voltage on the basis of the value of the detection result. When detecting the change in the electric characteristics, each rotary member such as the developing roller 4 is rotationally driven by the motor M1 similarly to during image formation. The operation of detecting the change in the electric characteristics as described above is an example of the predetermined non-image-forming operation.

In addition, when a recording material of a size (for example, a postcard size) smaller than normal in the longitudinal direction of the fixing device 14 (direction of the rotation axis of the photosensitive drum 1, main scanning direction in image formation) is used, there is a case where the temperature distribution in the longitudinal direction in the fixing device 14 becomes uneven. When the image forming operation is executed on the recording material of a normal size (for example, the A4 size) in a state in which the temperature distribution is uneven as described above, the gloss of the image can be uneven, and therefore an operation of cancelling the uneven temperature distribution may be executed after the image forming job on the recording material of a short size. When cancelling the temperature unevenness, each rotary member such as the developing roller 4 and the fixing roller is rotationally driven by the motor M1 similarly to during image formation. The operation of cancelling the temperature unevenness is an example of the predetermined non-image-forming operation.

### Example 2

The image forming apparatus 100 according to another embodiment (Example 2) will be described. Example 2 is different from Example 1 in that the threshold value of the inter-replenishment specific traveling distance Rn serving as a standard for the mode change of the controller 200 is changed in accordance with not only the cumulative replenishment count H0 but also the amount of toner (replenishment amount Hk) supplied for replenishment in the replenishment operation. In the description below, elements substantially the same as in Example 1 will be denoted by the same reference signs and description thereof will be omitted, and part different from Example 1 will be mainly described.

The relationship between a threshold value W2 of the inter-replenishment specific traveling distance Rn and the replenishment amount Hk in Example 2 will be described. When focusing on one toner particle, the frequency of the toner particle being borne on the developing roller 4 and rubbed by the supply roller 5 and the developing blade 6 is higher in the case where the amount of the toner 3 in the developing container 80 is smaller. That is, in the case where the amount of the toner 3 in the developing container 80 is smaller, the progress of the deterioration of the toner 3 becomes faster, and the allowable value of the inter-replenishment specific traveling distance Rn becomes smaller. Therefore, in the case where the replenishment amount Hk in the replenishment operation is not constant, it may be preferable to make the threshold value of the inter-replenishment specific traveling distance Rn smaller as the replenishment amount Hk is smaller. That is, in the case where the cumulative number of times of the replenishment operation is the same, it may be preferable that the threshold value W2 is smaller when the amount of developer supplied for replenishment by the replenishment operation (replenishment amount Hk) is a second amount (for example, 50 g) smaller than a first amount (for example, 100 g) than when the replenishment amount Hk is the first amount.

The threshold value W2 of the inter-replenishment specific traveling distance Rn in Example 2 is calculated by, for example, Formula (1).

$$W 2 = W 1 \times Hk / 100 \qquad Formula ( 1 )$$

In Formula (1), W1 represents the threshold value of the inter-replenishment specific traveling distance Rn set for each value of the cumulative replenishment count H0 in the case where it is assumed that the replenishment amount Hk is constant. W1 may be equal to a value shown in Table 1 used in the description of Example 1. In addition, the information indicating the correspondence between the cumulative replenishment count H0 and W1 is stored in advance in the ROM 203. In addition, “100 (g)”, which is the denominator on the right side, represents the maximum amount of toner that can be supplied for replenishment in one time of replenishment operation (maximum value of replenishment amount Hk), and this value can be changed in accordance with the capacity of the developing container 80.

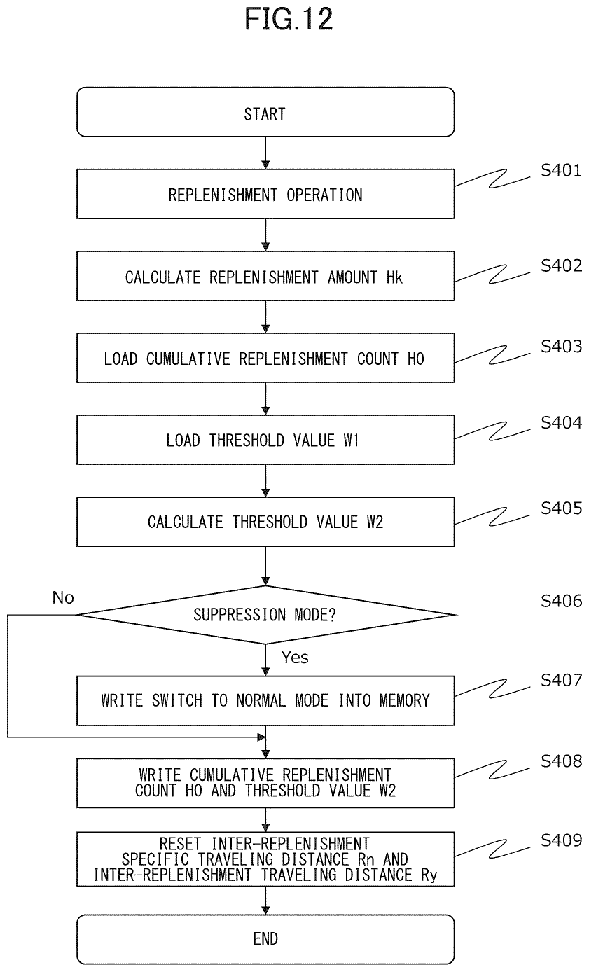

A calculation method for the threshold value W2 in Example 2 will be described with reference to FIG. 12. FIG. 12 is a flowchart illustrating a control example related to calculation of the threshold value W2 in Example 2. Here, the calculation of the threshold value W2 will be described as part of the control (corresponding to FIG. 9 of Example 1) related to the switch from the suppression mode to the normal mode.

When the replenishment operation is executed by the operator (S401), the controller 200 calculates the replenishment amount Hk by using the toner amount sensor 20 (S402). The controller 200 uses, as the replenishment amount Hk, for example, a value obtained by subtracting the toner amount in the developing container 80 detected by using the toner amount sensor 20 immediately before the replenishment operation from the toner amount in the developing container 80 detected by using the toner amount sensor 20 immediately after the replenishment operation. To be noted, the operator may input information related to the replenished toner amount via the operation panel 60 as one of procedure steps of the replenishment operation. In this case, the controller 200 can grasp the replenishment amount Hk on the basis of the input information.

In step S403, the controller 200 communicates with the memory 15, and loads the cumulative replenishment count H0 thus far. In step S404, the controller 200 refers to the information of Table 1, and loads the threshold value W1 corresponding to the current value of the cumulative replenishment count H0. In step S405, the controller 200 calculates the threshold value W2 on the basis of the replenishment amount Hk and the threshold value W1 by using Formula (1).

In step S406, the controller 200 determines whether or not the current control mode is the normal mode. In the case where it is determined that the current control mode is the suppression mode, the controller 200 writes the switch from the suppression mode to the normal mode into the memory 15 (S407). In contrast, in the case where it is determined that the current control mode is the normal mode, the controller 200 skips step S407 and proceeds to step S408.

In step S408, the controller 200 communicates with the memory 15, writes the value calculated in step S405 as the threshold value W2, and writes a value obtained by adding 1 to the current value as the cumulative replenishment count H0. In step S409, the controller 200 resets the inter-replenishment specific traveling distance Rn and the inter-replenishment traveling distance Ry. That is, the controller 200 communicates with the memory 15, and writes Rn=0 and Ry=0. As a result of this, the controller 200 finishes the processing of the present flow.

### Evaluation Experiment

Also in the present example, substantially the same experiment as the experiment conducted in Example 1 was conducted. To be noted, the replenishment amount Hk was set to Hk=50 (g) for the replenishment operation of the odd-numbered time in the cumulative replenishment count H0, and the replenishment amount Hk was set to Hk=100 (g) for the replenishment of even-numbered time in the cumulative replenishment count H0. That is, 50 g of toner was supplied for replenishment in the first replenishment operation from the brand-new state, 100 g of toner was supplied for replenishment in the second replenishment operation, and then 50 g of toner and 100 g of toner were supplied for replenishment alternately. Table 3 shows the threshold value W2 for each cumulative replenishment count H0 in the present experiment.

TABLE 3

| | Cumulative replenishment count H0 | | | | | | | | | |
|---|---|---|---|---|---|---|---|---|---|---|
| | 0 | 1 | 2 | 3 | 4 | 5 | 6 | 7 | 8 | 9 |
| Threshold | 5.3 | 2.0 | 2.7 | 0.65 | 1.3 | 0.65 | 1.3 | 0.65 | 1.3 | 0.65 |
| value W2 (km) | | | | | | | | | | |

The threshold value W2 roughly decreases as the cumulative replenishment count H0 increases. In addition, for the replenishment operation of the odd-numbered time in the cumulative replenishment count H0, the replenishment amount Hk is small, and therefore the threshold value W2 after the replenishment operation is small. In contrast, for the replenishment operation of the even-numbered time in the cumulative replenishment count H0, the replenishment amount Hk is large, and therefore the threshold value W2 after the replenishment operation is large.

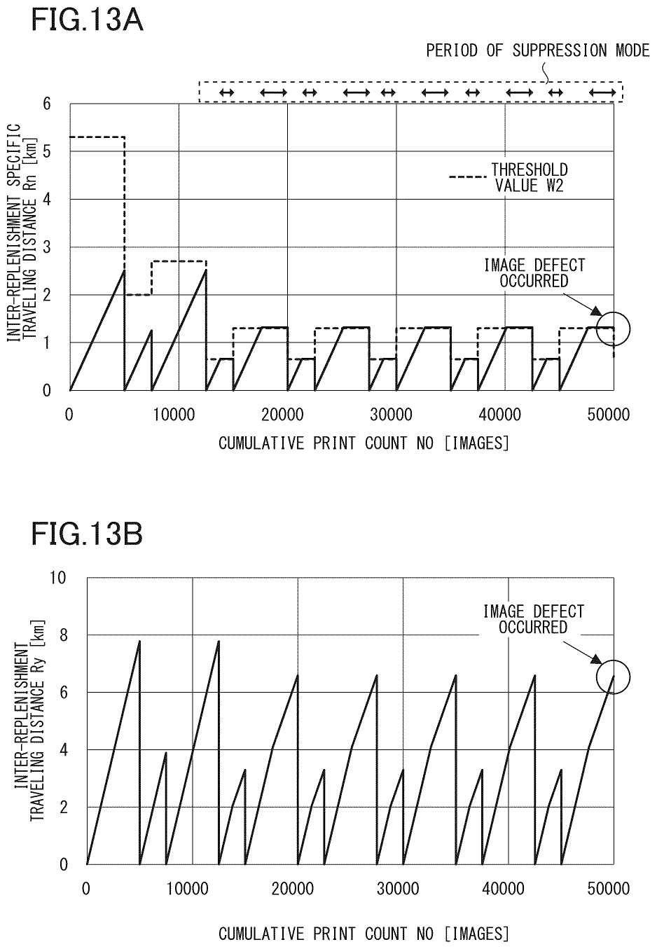

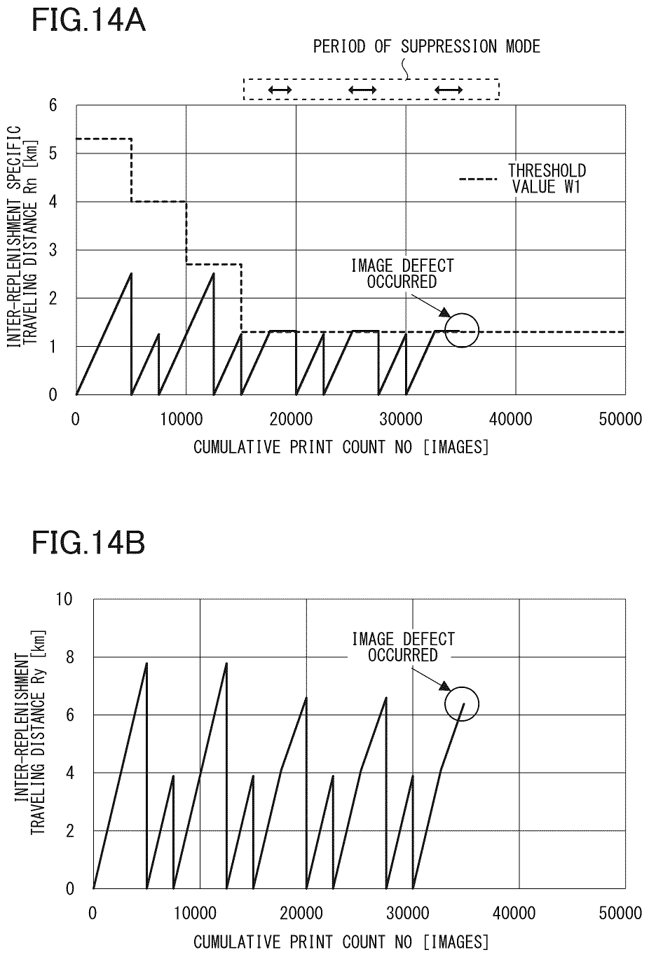

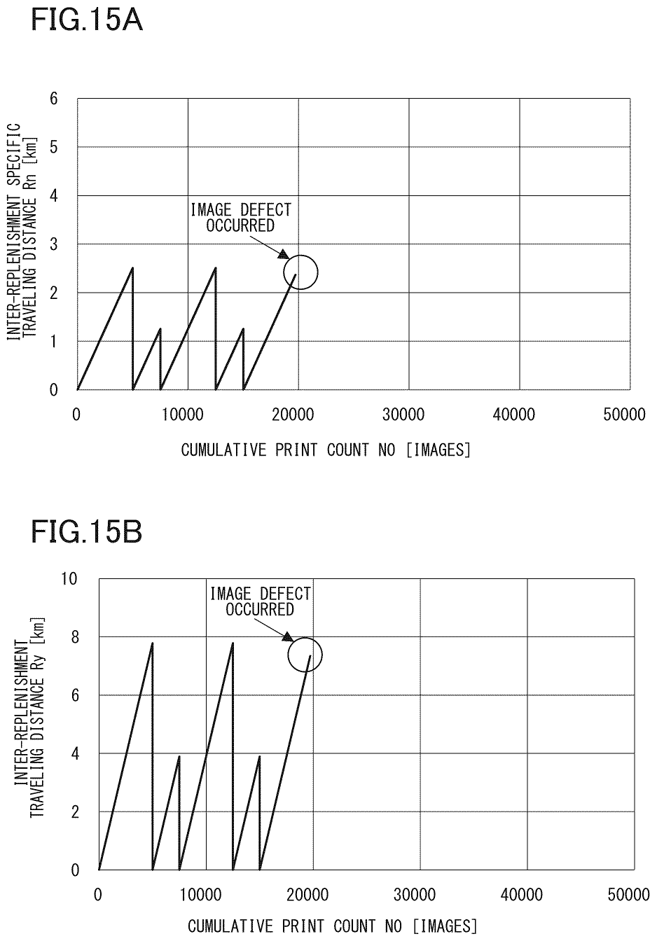

As comparative targets, results of experiment conducted by the same method as in Example 2 in the configurations of Example 1 and Comparative Example 1 will be respectively referred to as Comparative Example 2-1 and Comparative Example 2-2. FIGS. 13A and 13B illustrate the transition of the inter-replenishment specific traveling distance Rn and the inter-replenishment traveling distance Ry with respect to the cumulative print count N0 in Example 2. FIGS. 14A and 14B illustrate the transition of the inter-replenishment specific traveling distance Rn and the inter-replenishment traveling distance Ry with respect to the cumulative print count N0 in Comparative Example 2-1. FIGS. 15A and 15B illustrate the transition of the inter-replenishment specific traveling distance Rn and the inter-replenishment traveling distance Ry with respect to the cumulative print count N0 in Comparative Example 2-2.

As illustrated in FIG. 15A, in Comparative Example 2-2, the normal mode is continued regardless of the inter-replenishment specific traveling distance Rn, and the predetermined non-image-forming operation (pre-start operation and toner remainder amount detection operation) is executed at a constant frequency. Therefore, as illustrated in FIGS. 15A and 15B, the inter-replenishment specific traveling distance Rn and the inter-replenishment traveling distance Ry increase at a constant speed with respect to the cumulative print count N0 while being reset each time the replenishment operation is executed.

In contrast, as illustrated in FIG. 14A, in Comparative Example 2-1 (Example 1), the mode change from the normal mode to the suppression mode is executed when the inter-replenishment specific traveling distance Rn exceeds the threshold value W1. In the period of the suppression mode, the predetermined non-image-forming operation (pre-start operation and toner remainder amount detection operation) is not executed, and therefore the increase of the inter-replenishment specific traveling distance Rn stops. In addition, since the increase of the inter-replenishment specific traveling distance Rn stops, the increase speed of the inter-replenishment traveling distance Ry becomes lower as illustrated in FIG. 14B.

To be noted, in Comparative Example 2-1 (Example 1), since the threshold value W1 is set regardless of whether or not the replenishment amount Hk in the replenishment operation is large, and therefore, particularly in the case where the replenishment amount Hk is small, there is a period in which the normal mode is executed in a state in which the toner amount in the developing container 80 is small. Therefore, deterioration of the toner can progress rapidly in such a period.

In contrast, in Example 2 illustrated in FIG. 13A, the threshold value W2 of the inter-replenishment specific traveling distance Rn serving as a standard for the mode change from the normal mode to the suppression mode is changed in accordance with the replenishment amount Hk in the most recent replenishment operation. As a result of this, for example, in the section where the cumulative print count N0 is 12,500 to 15,000, the threshold value W2 is set to be low although the cumulative print count N0 is smaller than in the section in which the cumulative print count N0 is 15,000 to 20,000. That is, in the section in which the cumulative print count N0 is 12,500 to 15,000 that is the most recent section in which the replenishment amount Hk is small, the mode change to the suppression mode is executed at a timing earlier than the section in which the cumulative print count N0 is 15,000 to 20,000 that is the most recent section in which the replenishment amount Hk is large. In the period of the suppression mode, the predetermined non-image-forming operation is not executed, therefore the increase of the inter-replenishment specific traveling distance Rn stops, and the increase speed of the inter-replenishment traveling distance Ry becomes lower as illustrated in FIG. 13B.

Therefore, in Example 2 illustrated in FIG. 13A, the inter-replenishment specific traveling distance Rn exceeds the threshold value W2 also in the section in which the cumulative print count N0 is 12,500 to 15,000 where the mode change to the suppression mode is not executed in Comparative Example 2-1 of FIG. 14A. That is, even in a situation in which the mode change to the suppression mode is not executed in the configuration of Example 1, there is a case where the mode change to the suppression mode is executed on the basis of the threshold value W2 set in consideration of the most recent replenishment amount Hk in Example 2.

Then, when the replenishment operation is executed, the inter-replenishment specific traveling distance Rn is reset, and the mode is switched from the suppression mode to the normal mode. As a result of this, Rn starts increasing again with respect to the cumulative print count N0, and the increase rate of Ry also increases. When the inter-replenishment specific traveling distance Rn exceeds the threshold value W2 again, the mode change from the normal mode to the suppression mode is executed again.

Also after this, after the replenishment operation of the odd-numbered time in which the replenishment amount Hk is small, the threshold value W2 is set to a smaller value than after the replenishment operation of the even-numbered time in which the replenishment amount Hk is large. That is, after the replenishment operation in which the replenishment amount Hk is small, the mode change from the normal mode to the suppression mode is executed at a time when the value of the inter-replenishment specific traveling distance Rn is relatively smaller than after the replenishment operation in which the replenishment amount Hk is large.

As described above, according to Example 2, in the case where the replenishment amount Hk in the replenishment operation is small, the controller 200 is switched from the normal mode to the suppression mode earlier than in the configuration of Example 1. Therefore, the possibility that the deterioration of toner is accelerated by executing the normal mode in a state in which the toner amount in the developing container 80 is small can be lowered, and the occurrence of image fogging can be further reduced as compared with Example 1.

TABLE 4

| | | Comparative | Comparative |
|---|---|---|---|
| | Example 2 | Example 2-1 | Example 2-2 |
| Cumulative print count N0 | 50,000 | 35,000 | 19,500 |
| at the time of occurrence | | | |
| of image fogging | | | |

Table 4 shows, as the evaluation results of the present experiment, the cumulative print count N0 when image fogging occurred in Example 2 and Comparative Examples 2-1 and 2-2. In Example 2, image fogging occurred when the cumulative print count N0 was 50,000. In Comparative Example 2-1, image fogging occurred when the cumulative print count N0 was 35,000. In Comparative Example 2-2, image fogging occurred when the cumulative print count N0 was 19,500.

The results of Table 4 show that occurrence of image fogging can be suppressed by the control of Example 2 as compared with Comparative Examples 2-1 and 2-2. This is because by executing the switch from the normal mode to the suppression mode on the basis of the value of the inter-replenishment specific traveling distance Rn, execution of the predetermined non-image-forming operation is suppressed, and the deterioration of the toner and the consumption of the developing roller 4 are suppressed.

Particularly, the results of Table 4 show that occurrence of image fogging can be further suppressed by the control of Example 2 as compared with Comparative Example 2-1 corresponding to Example 1. This is because by setting the threshold value W2 in consideration of the replenishment amount Hk in the most recent replenishment operation, the switch from the normal mode to the suppression mode is executed early in the case where the replenishment amount Hk is small, and thus deterioration of the toner and consumption of the developing roller 4 are further suppressed.

As described above, according to Example 2, the mode change from the normal mode to the suppression mode is performed on the basis of the inter-replenishment specific traveling distance Rn, and execution of the predetermined non-image-forming operation is suppressed. As a result of this, progress of the deterioration of the toner can be suppressed, and thus occurrence of image fogging can be suppressed.

Further, according to Example 2, the threshold value W2 for determining the switch timing to the suppression mode is determined on the basis of the cumulative replenishment count H0 and the replenishment amount Hk. Therefore, as compared with Example 1 in which the threshold value W1 is determined regardless of the replenishment amount Hk, deterioration of toner can be suppressed further, and occurrence of image fogging can be suppressed further.

### Example 3

The image forming apparatus 100 according to another embodiment (Example 3) will be described. Example 3 is different from Example 1 in that the threshold value of the inter-replenishment specific traveling distance Rn serving as a standard for the mode change of the controller 200 is changed in accordance with not only the cumulative replenishment count H0 but also the toner amount T in the developing container 80. In the description below, elements substantially the same as in Example 1 will be denoted by the same reference signs and description thereof will be omitted, and part different from Example 1 will be mainly described.

The relationship between a threshold value W3 of the inter-replenishment specific traveling distance Rn and the replenishment amount Hk in Example 3 will be described. As described above, when focusing on one toner particle, the frequency of the toner particle being borne on the developing roller 4 and rubbed by the supply roller 5 and the developing blade 6 is higher in the case where the amount of the toner 3 in the developing container 80 is smaller. That is, in the case where the amount of the toner 3 in the developing container 80 is smaller, the progress of the deterioration of the toner 3 becomes faster, and the allowable value of the inter-replenishment specific traveling distance Rn becomes smaller. Therefore, it may be preferable that the threshold value W3 of the inter-replenishment specific traveling distance Rn becomes smaller as the toner amount T in the developing container 80 becomes smaller.

The threshold value W3 of the inter-replenishment specific traveling distance Rn in Example 3 is determined on the basis of, for example, Table 5. The information shown in Table 5 is stored in, for example, the ROM 203 in advance.

TABLE 5

| | | Cumulative replenishment count H0 | | | |
|---|---|---|---|---|---|
| Threshold value W3 | | 0 | 1 | 2 | 3 or more |
| Toner | 80 g ≤ T | 5.3 km | 4.0 km | 2.7 km | 1.3 km |
| amount T | 70 g ≤ T < 80 g | 4.2 km | 3.2 km | 2.1 km | 1.1 km |
| | 60 g ≤ T < 70 g | 3.2 km | 2.4 km | 1.6 km | 0.8 km |
| | T < 60 g | 2.7 km | 1.6 km | 1.1 km | 0.5 km |

As shown in Table 5, in the case of comparing in a condition in which the toner amount T in the developing container 80 is the same, it may be preferable that the threshold value W3 is set to be smaller as the cumulative replenishment count H0 is larger. In the case where the cumulative replenishment count H0 is fixed, it may be preferable that the threshold value W3 is set to be smaller as the toner amount T in the developing container 80 is smaller. In other words, in the case where the cumulative number of times of the replenishment operation is the same, it may be preferable that the threshold value W3 is smaller when the amount of developer in the developing container 80 (accommodation portion) is a fourth amount (for example, 60 g) smaller than a third amount (for example, 80 g) than when the amount of developer in the developing container 80 is the third amount.

### Evaluation Experiment

Also in the present example, substantially the same experiment as the experiment conducted in Example 1 was conducted. To be noted, the amount (replenishment amount Hk) of toner supplied for replenishment in one time of replenishment operation was set to be constant similarly to the evaluation experiment of Example 1 (Hk=100 (g)).

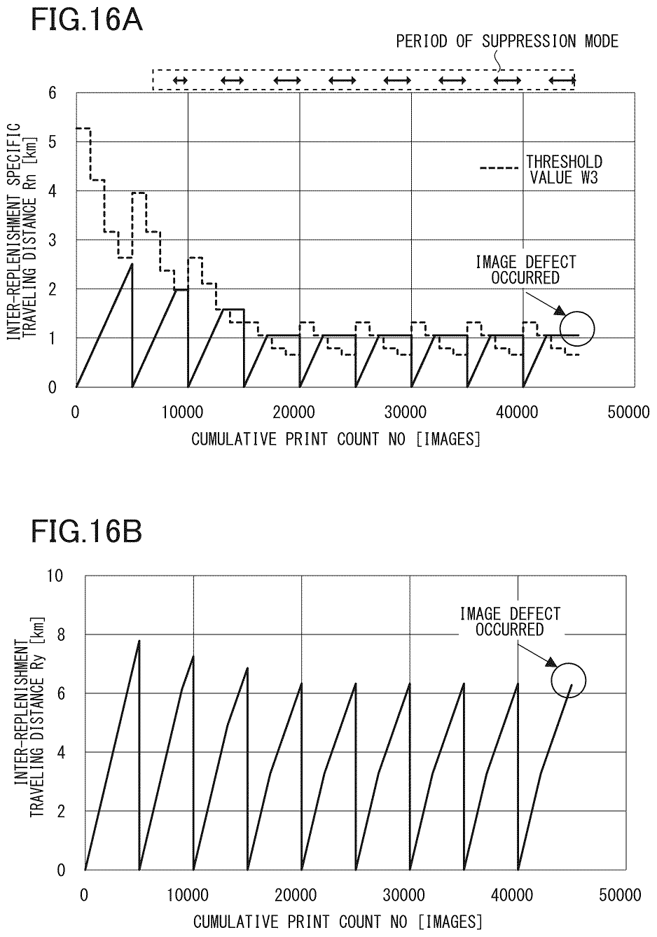

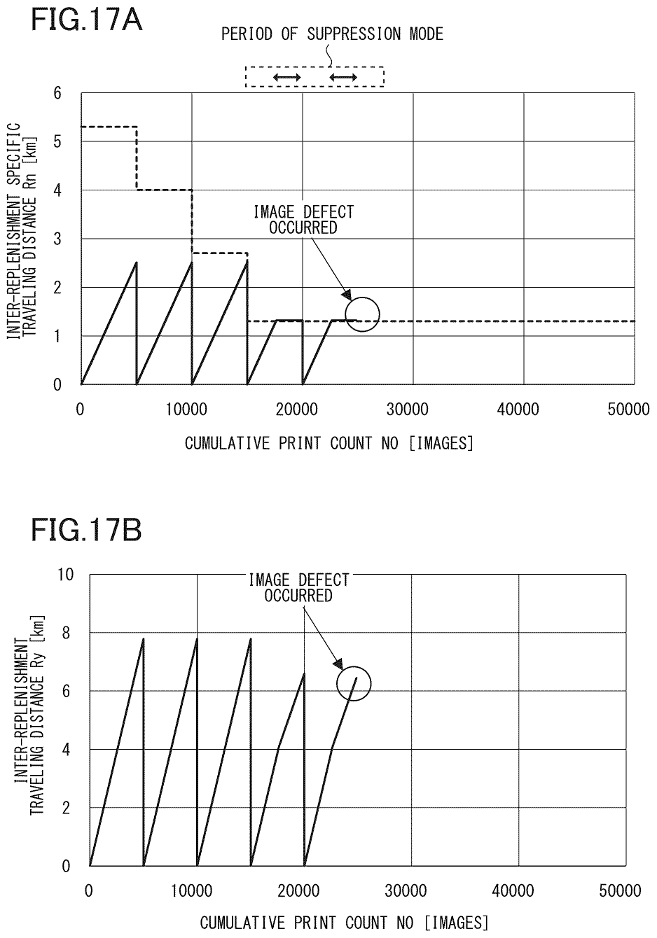

As comparative targets, results of experiment conducted by the same method as in Example 3 in the configuration of Example 1 will be referred to as Comparative Example 3. FIGS. 16A and 16B illustrate the transition of the inter-replenishment specific traveling distance Rn and the inter-replenishment traveling distance Ry with respect to the cumulative print count N0 in Example 3. FIGS. 17A and 17B illustrate the transition of the inter-replenishment specific traveling distance Rn and the inter-replenishment traveling distance Ry with respect to the cumulative print count N0 in Comparative Example 3.

As illustrated in FIG. 17A, in Comparative Example 3 (Example 1), the mode change from the normal mode to the suppression mode is executed when the inter-replenishment specific traveling distance Rn exceeds the threshold value W1. In the period of the suppression mode, the predetermined non-image-forming operation (pre-start operation and toner remainder amount detection operation) is not executed, and therefore the increase of the inter-replenishment specific traveling distance Rn stops. In addition, since the increase of the inter-replenishment specific traveling distance Rn stops, the increase speed of the inter-replenishment traveling distance Ry becomes lower as illustrated in FIG. 17B.

To be noted, in Comparative Example 3 (Example 1), since the threshold value W1 is set regardless of whether or not the toner amount T in the developing container 80 is large, particularly in a state in which the toner amount T is small, deterioration of the toner can progress rapidly.

In contrast, in Example 3 illustrated in FIG. 16A, the threshold value W3 of the inter-replenishment specific traveling distance Rn serving as a standard for the mode change from the normal mode to the suppression mode is changed in accordance with the toner amount T in the developing container 80. In the present example, the threshold value W3 is changed stepwise to smaller values as the toner amount T in the developing container 80 decreases.

As a result of this, for example, even in the section where the cumulative print count NO is 5,000 to 10,000 in which the mode is not switched to the suppression mode in Comparative Example 3 (FIG. 17A), the inter-replenishment specific traveling distance Rn exceeds the threshold value W3 and the mode switches to the suppression mode in Example 3 (FIG. 16A). That is, in Example 3, there is a case where the mode change to the suppression mode is executed on the basis of the threshold value W3 set in consideration of the toner amount T in the developing container 80, even in a situation in which the mode change to the suppression mode is not executed in the configuration of Example 1. In the period of the suppression mode, the predetermined non-image-forming operation is not executed and the increase of the inter-replenishment specific traveling distance Rn stops, and therefore the increase speed of the inter-replenishment traveling distance Ry becomes lower as illustrated in FIG. 16B.

Then, when the replenishment operation is executed, the inter-replenishment specific traveling distance Rn is reset, and the control mode is switched from the suppression mode to the normal mode. As a result of this, Rn starts increasing again with respect to the cumulative print count N0, and the increase rate of Ry also increases. In addition, as a result of the increase in the toner amount T in the developing container 80 by the replenishment operation, the threshold value W3 is changed to a value (Table 5) corresponding to the toner amount T after the replenishment. When the inter-replenishment specific traveling distance Rn exceeds the threshold value W3 again, the mode change from the normal mode to the suppression mode is executed again.

Also after this, the mode change from the normal mode to the suppression mode is executed on the basis of the threshold value W3 that decreases stepwise in accordance with the decrease of the toner amount T in the developing container 80. Therefore, whereas the suppression mode is not executed in the section until the cumulative print count N0 reaches 15,000 in Comparative Example 3, the mode change to the suppression mode is executed each time the inter-replenishment specific traveling distance Rn exceeds the threshold value W3 in the same section in Example 3.

As described above, according to Example 3, the mode change from the normal mode to the suppression mode is executed earlier than in the configuration of Example 1 in the case where, for example, the predetermined non-image-forming operation is executed at a high frequency in a state in which the toner amount T in the developing container 80 is small. Therefore, the possibility that the deterioration of toner is accelerated by executing the normal mode in a state in which the toner amount in the developing container 80 is small can be lowered, and the occurrence of image fogging can be further reduced as compared with Example 1.

TABLE 6

| | | Comparative |
|---|---|---|
| | Example 3 | Example 3 |
| Cumulative print count N0 at the time | 45,000 | 25,000 |
| of occurrence of image fogging | | |

Table 6 shows, as the evaluation results of the present experiment, the cumulative print count N0 when image fogging occurred in Example 3 and Comparative Example 3. In Example 3, image fogging occurred when the cumulative print count N0 was 45,000. In Comparative Example 3, image fogging occurred when the cumulative print count N0 was 25,000.

The results of Table 6 show that occurrence of image fogging can be further suppressed by the control of Example 3 as compared with Comparative Example 3 (Example 1). This is because as a result of the configuration in which the threshold value W3 decreases in accordance with the decrease of the toner amount T in the developing container 80, the mode change to the suppression mode is executed earlier in a state in which the toner amount T in the developing container 80 is small. As a result of switching earlier to the suppression mode in the case where the toner amount T in the developing container 80 is small, a situation in which the predetermined non-image-forming operation is executed in a state in which the toner amount T in the developing container 80 is small and deterioration of the toner progresses or the like can be avoided, and thus occurrence of image fogging can be further suppressed.

As described above, according to Example 3, the mode change from the normal mode to the suppression mode is performed on the basis of the inter-replenishment specific traveling distance Rn, and execution of the predetermined non-image-forming operation is suppressed. As a result of this, progress of the deterioration of the toner can be suppressed, and occurrence of image fogging can be suppressed.

Further, according to Example 3, the threshold value W3 for determining the switch timing to the suppression mode is changed on the basis of the cumulative replenishment count H0 and the toner amount T in the developing container 80. Therefore, for example, as compared with Example 1 in which the threshold value W1 is not changed even when the toner amount T in the developing container 80 decreases, deterioration of toner can be suppressed further, and occurrence of image fogging can be suppressed further.

### Modification Example

In Example 3, the threshold value W3 is determined regardless of the replenishment amount Hk of toner by the replenishment operation. The configuration is not limited to this, and the threshold value W3 may be determined on the basis of the cumulative replenishment count H0, the toner amount T in the developing container 80, and the replenishment amount Hk of toner by the replenishment operation. That is, Example 2 and Example 3 may be combined. In this case, the value of W2 obtained by substituting W1 of the Formula (1) of Example 2 by the value of W3 determined on the basis of the cumulative replenishment count H0 and the toner amount T in the developing container 80 by the method of Example 3 may be used as the threshold value for the inter-replenishment specific traveling distance Rn.

### OTHER EMBODIMENTS

In Examples 1 to 3, a configuration in which the controller 200 automatically switches from the normal mode to the suppression mode in the case where the inter-replenishment specific traveling distance Rn exceeds the threshold value W1/W2/W3 has been described. The configuration is not limited to this, and for example, notification processing of prompting the operator to change the mode to the suppression mode via the operation panel 60 may be executed in the case where the inter-replenishment specific traveling distance Rn exceeds the threshold value W1/W2/W3. In this case, the controller 200 can switch from the normal mode to the suppression mode on the basis of an instruction from the operator.

In each example described above, a configuration in which the mode change from the normal mode to the suppression mode is executed as first processing of lowering the execution frequency of the predetermined non-image-forming operation in the case where the inter-replenishment specific traveling distance Rn exceeds the threshold value W1/W2/W3 has been described as an example. Whether or not to execute the predetermined non-image-forming-operation (or a parameter to adjust the execution frequency) in the suppression mode is set in advance. The configuration is not limited to this, and the first processing may be processing of directly changing the parameter determining the execution frequency of the predetermined non-image-forming operation. For example, in a configuration in which the controller 200 executes the toner remainder amount detection operation at the end of the job each time the cumulative print count N0 increases by a predetermined number, the first processing may be processing of increasing the predetermined number (for example, from 10 to 100).

In addition, in each example described above, although a configuration in which the processing (first processing) of lowering the execution frequency of the predetermined non-image-forming operation is executed in the case where the inter-replenishment specific traveling distance Rn exceeds the threshold value W1/W2/W3 has been described as an example, the method to suppress deterioration of the toner is not limited to this. In the case where Rn exceeds the threshold value W1/W2/W3, the execution condition of the predetermined non-image-forming operation may be changed to shorten the time in which the motor M1 rotationally drives the developing roller 4 in the predetermined non-image-forming operation. For example, it is assumed that in normal settings, the toner amount in the developing container 80 is detected by obtaining the signal of the toner amount sensor 20 while the motor M1 drives the developing device 8 for a first period (for example, 60 seconds) in the toner remainder amount detection operation at the end of the job. In this case, in the case of executing the toner remainder amount detection operation at the end of the job after Rn exceeds the threshold value W1/W2/W3, the signal of the toner amount sensor 20 may be obtained while the motor M1 drives the developing device 8 for a second period (for example, 30 seconds) shorter than the first period.

As described above, there is a case where the image forming apparatus executes the non-image-forming operation while not executing the image forming operation. However, there is a case where the image defect occurs as a result of the progress of the deterioration of toner by the non-image-forming operation.

According to the present disclosure, an image forming apparatus capable of suppressing the deterioration of toner can be provided.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and perform the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-037722, filed Mar. 10, 2025, which is hereby incorporated by reference herein in its entirety.

What is claimed is:

1. An image forming apparatus comprising:
an image bearing member;
an accommodation portion configured to accommodate a developer;
an attachment portion configured to allow a replenishment container to be attached and detached, the attachment portion including a replenishment port communicating with the accommodation portion;
a developer bearing member configured to rotate while bearing the developer in the accommodation portion and develop a developer image by supplying the developer to the image bearing member; and
a controller configured to execute an image forming operation of forming an image on a recording material by using the image bearing member and the developer bearing member, and a predetermined non-image-forming operation of not forming the image on the recording material, the predetermined non-image-forming operation including an operation of rotating the developer bearing member,
wherein the accommodation portion is configured to be replenished with the developer by a replenishment operation in which the developer is supplied to the accommodation portion from the replenishment container attached to the attachment portion through the replenishment port and then the replenishment container is detached from the attachment portion, and
wherein the controller is configured to, in a case where a value related to a cumulative traveling distance of the developer bearing member in the predetermined non-image-forming operation from a time point when the replenishment operation is executed exceeds a predetermined threshold value, execute first processing to lower an execution frequency of the predetermined non-image-forming operation as compared with before the value related to the cumulative traveling distance exceeds the threshold value.

2. The image forming apparatus according to claim 1,
wherein the controller is configured to, in a case where the replenishment operation for a next time is executed after the first processing is executed, execute second processing of increasing the execution frequency of the predetermined non-image-forming operation as compared with a period from execution of the first processing to the replenishment operation for the next time.

3. The image forming apparatus according to claim 2,
wherein the controller is capable of executing a first mode in which the predetermined non-image-forming operation is executed in a non-image-forming period in which the image forming operation is not executed, and a second mode in which an execution frequency of the predetermined non-image-forming operation in the non-image-forming period is lower than in the first mode,
wherein the first processing is processing to change a mode to be executed by the controller from the first mode to the second mode, and
wherein the second processing is processing to change the mode to be executed by the controller from the second mode to the first mode.

4. The image forming apparatus according to claim 3,
wherein the second mode is a mode in which the predetermined non-image-forming operation is not executed.

5. The image forming apparatus according to claim 1,
wherein the controller is configured to reset the value related to the cumulative traveling distance each time the replenishment operation is executed.

6. The image forming apparatus according to claim 5,
wherein the controller is configured to update the threshold value on a basis of a cumulative number of times the replenishment operation has been executed.

7. The image forming apparatus according to claim 6,
wherein the threshold value is smaller in a case where the cumulative number of times is a second number larger than a first number than in a case where the cumulative number of times is the first number.

8. The image forming apparatus according to claim 5,
wherein the controller is configured to change the threshold value on a basis of a cumulative number of times the replenishment operation has been executed and an amount of the developer supplied in the replenishment operation.

9. The image forming apparatus according to claim 8,
wherein in a case where the cumulative number of times is the same, the threshold value is smaller in a case where an amount of the developer supplied in the replenishment operation is a second amount smaller than a first amount than in a case where the amount of the developer supplied in the replenishment operation is the first amount.

10. The image forming apparatus according to claim 5, further comprising:
a detection portion configured to detect an amount of the developer in the accommodation portion,
wherein the controller is configured to change the threshold value on a basis of a cumulative number of times the replenishment operation has been executed and the amount of the developer detected by the detection portion.

11. The image forming apparatus according to claim 10,
wherein in a case where the cumulative number of times is the same, the threshold value is smaller in a case where the amount of the developer in the accommodation portion is a fourth amount smaller than a third amount than in a case where the amount of the developer in the accommodation portion is the third amount.

12. The image forming apparatus according to claim 1,
wherein the predetermined non-image-forming operation includes a first preliminary operation of preparing for the image forming operation before the controller receives a start instruction of the image forming operation,
wherein the controller is capable of executing a second preliminary operation of preparing for the image forming operation after receiving the start instruction, and
wherein the controller is configured to:
start the image forming operation without executing the second preliminary operation in a case of receiving the start instruction while the first preliminary operation is executed; and
start the image forming operation after executing the second preliminary operation in a case of receiving the start instruction while the first preliminary operation is not executed.

13. The image forming apparatus according to claim 12, further comprising:
an exposing device configured to expose the image bearing member by irradiating the image bearing member with light;
a video controller configured to perform analysis of image data and control the exposing device;
a fixing device configured to heat the developer image transferred onto a recording material via the image bearing member and fix the developer image to the recording material; and
a motor configured to drive the developer bearing member and the fixing device,
wherein the controller is configured to control the motor and the fixing device,
wherein the video controller is configured to issue a preparation instruction instructing to prepare for the image forming operation to the controller in response to reception of an image formation command together with the image data from outside, and then issue the start instruction to the controller, and
wherein the first preliminary operation is an operation of heating the fixing device while rotating the motor before receiving the start instruction, in response to the controller receiving the preparation instruction from the video controller.

14. The image forming apparatus according to claim 1, further comprising:
a detection portion configured to output a signal corresponding to an amount of the developer in the accommodation portion;
an agitation member disposed in the accommodation portion and configured to agitate the developer in the accommodation portion; and
a motor configured to drive the developer bearing member and the agitation member,
wherein the predetermined non-image-forming operation includes a detection operation of detecting the amount of the developer by using the detection portion while rotating the motor after the image forming operation is finished.

15. The image forming apparatus according to claim 14,
wherein the controller is configured to:
(i) after the replenishment operation is executed and before the value related to the cumulative traveling distance exceeds the threshold value, execute the detection operation for a next time in a case where a cumulative execution number of the image forming operation after execution of the detection operation of a previous time is equal to or more than a first predetermined number; and
(ii) after the value related to the cumulative traveling distance exceeds the threshold value and before the replenishment operation for the next time is executed, (ii-1) execute the detection operation for the next time in a case where the cumulative execution number is equal to or larger than a second predetermined number larger than the first predetermined number, or (ii-2) not execute the detection operation even in a case where the cumulative execution number has increased.

16. The image forming apparatus according to claim 1,
wherein the attachment portion is configured such that the developer is supplied to the accommodation portion through the replenishment port from the replenishment container attached to the attachment portion in a state in which at least part of the replenishment container is exposed to an outside of the image forming apparatus.

17. The image forming apparatus according to claim 1,
wherein the developer not transferred from the image bearing member to a transfer receiving member is collected into the accommodation portion by the developer bearing member.

18. An image forming apparatus comprising:
an image bearing member;
an accommodation portion configured to store a developer;
an attachment portion configured to allow a replenishment container to be attached and detached, the attachment portion including a replenishment port communicating with the accommodation portion;
a developer bearing member configured to rotate while bearing the developer in the accommodation portion and develop a developer image by supplying the developer to the image bearing member; and
a controller configured to execute an image forming operation of forming an image on a recording material by using the image bearing member and the developer bearing member, and a predetermined non-image-forming operation of not forming the image on the recording material, the predetermined non-image-forming operation including an operation of rotating the developer bearing member,
wherein the accommodation portion is configured to be replenished with the developer by a replenishment operation, in which the developer is supplied to the accommodation portion from the replenishment container attached to the attachment portion through the replenishment port and then the replenishment container is detached from the attachment portion, and
wherein the controller is configured to, in a case where a value related to a cumulative traveling distance of the developer bearing member in the predetermined non-image-forming operation from a time point when the replenishment operation is executed exceeds a predetermined threshold value, shorten a time in which the developer bearing member is rotationally driven in the predetermined non-image-forming operation as compared with before the value related to the cumulative traveling distance exceeds the threshold value.

19. The image forming apparatus according to claim 18,
wherein the predetermined non-image-forming operation includes a first preliminary operation of preparing for the image forming operation before the controller receives a start instruction of the image forming operation,
wherein the controller is capable of executing a second preliminary operation of preparing for the image forming operation after receiving the start instruction, and
wherein the controller is configured to:
start the image forming operation without executing the second preliminary operation in a case of receiving the start instruction while the first preliminary operation is executed; and
start the image forming operation after executing the second preliminary operation in a case of receiving the start instruction while the first preliminary operation is not executed.

20. The image forming apparatus according to claim 18, further comprising:
a detection portion configured to output a signal corresponding to an amount of the developer in the accommodation portion;
an agitation member disposed in the accommodation portion and configured to agitate the developer in the accommodation portion; and
a motor configured to drive the developer bearing member and the agitation member,
wherein the predetermined non-image-forming operation includes a detection operation of detecting the amount of the developer by using the detection portion while rotating the motor after the image forming operation is finished.
